(19) United States
(12) Patent Application Publication
(10) Pub. No.: US 2015/0354992 A1
(43) Pub. Date: Dec. 10, 2015

(54) ENCODER, SERVO SYSTEM, AND POSITION DATA GENERATION METHOD OF ENCODER

(71) Applicant: KABUSHIKI KAISHA YASKAWA DENKI, Kitakyushu-shi (JP)

(72) Inventors: Ikuma MUROKITA, Kitakyushu-shi (JP); Yasushi Yoshida, Kitakyushu-shi (JP)

(73) Assignee: KABUSHIKI KAISHA YASKAWA DENKI, Kitakyushu-shi (JP)

(21) Appl. No.: 14/727,915

(22) Filed: Jun. 2, 2015

(30) Foreign Application Priority Data
Jun. 9, 2014 (JP) 2014-118540

(51) Int. Cl. G01D 5/26; G05D 3/20

(52) U.S. Cl. CPC G01D 5/26; G05D 3/20

(57) ABSTRACT

An encoder includes a disc coupled to a rotating body and having first tracks and one or more second tracks, a light source which emits light to the first and second tracks, first arrays positioned mutually offset in width direction of the disc perpendicular to measurement direction of the first and second tracks such that the first arrays receive light reflected or transmitted by the first tracks and output first signals, two second arrays positioned to receive light reflected or transmitted by the second track such that the second arrays output two second signals having mutually different phases, and a device which generates position data of the body based on one or more first signals and one of the second signals selected based on the first signals. Each first track has an incremental pattern along the measurement direction, and the second track has an absolute pattern along the measurement direction.

### CROSS-REFERENCE TO RELATED APPLICATIONS

The present application is based upon and claims the benefit of priority to Japanese Patent Application No. 2014-118540, filed Jun. 9, 2014, the entire contents of which are incorporated herein by reference.

### BACKGROUND OF THE INVENTION

### 1. Field of the Invention

Embodiments disclosed herein relate to an encoder, a servo system, and a position data generation method of the encoder.

### 2. Description of Background Art

Japanese Patent Laid-Open Publication No. 2012-103032 describes a reflective encoder which includes incremental light receiving element groups divided and arranged in a circumferential direction of a rotating disc in a manner sandwiching a light source therebetween and two absolute light receiving element groups arranged on both an inner side and an outer side in a radial direction of the rotating disc with respect to the light source. The entire contents of this publication are incorporated herein by reference.

### SUMMARY OF THE INVENTION

According to one aspect of the present invention, an encoder includes a disc coupled to a rotating body and having first tracks and one or more second tracks, a light source which emits light to the first tracks and second track of the disc, multiple first light receiving arrays positioned at mutually offset positions in a width direction of the disc perpendicular to a measurement direction of the first tracks and second track such that the first light receiving arrays receive light reflected or transmitted by the first tracks and output first light receiving signals, respectively, two second light receiving arrays positioned to receive light reflected or transmitted by the second track such that the second light receiving arrays output two second light receiving signals having mutually different phases, respectively, and a position data generation device which generates position data of the rotating body based on one or more of the first light receiving signals and one of the two second light receiving signals selected based on the first light receiving signals. The first tracks are formed on or in the disc such that each of the first tracks has an incremental pattern along the measurement direction, and the second track is formed on or in the disc such that the second track has an absolute pattern along the measurement direction.

According to another aspect of the present invention, a method for generating position data of an encoder includes providing an encoder including a disc coupled to a rotating body and having first tracks and one or more second tracks, a light source which emits light to the first tracks and second track of the disc, multiple first light receiving arrays positioned at mutually offset positions in a width direction of the disc perpendicular to a measurement direction of the first tracks and second track such that the first light receiving arrays receive light reflected or transmitted by the first tracks and output first light receiving signals, respectively, and two second light receiving arrays positioned to receive light reflected or transmitted by the second track such that the second light receiving arrays output two second light receiving signals having mutually different phases, respectively, and generating a position data of the rotating body based on one or more of the first light receiving signals and one of the two second light receiving signals selected based on the first light receiving signals. The first tracks are formed on or in the disc such that each of the first tracks has an incremental pattern along the measurement direction, and the second track is formed on or in the disc such that the second track has an absolute pattern along the measurement direction.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an explanatory diagram for describing an outline of an exemplary structure of a servo system according to a first embodiment;

FIG. 2 illustrates an explanatory diagram for describing an exemplary structure of an encoder according to the first embodiment;

FIG. 3 illustrates an explanatory diagram for describing an exemplary structure of a disc according to the first embodiment;

FIG. 4 illustrates an explanatory diagram for describing an exemplary structure of a track according to the first embodiment;

FIG. 5 illustrates an explanatory diagram for describing an exemplary structure of an optical module according to the first embodiment;

FIG. 6 illustrates an explanatory diagram for describing an exemplary structure of a controller according to the first embodiment;

FIG. 7 illustrates an explanatory diagram for describing an example of a waveform of first data and examples of waveforms of respective absolute signals, in a case where there exists no eccentricity between the disc and a shaft and an optical module is not arranged tilted in a rotation direction;

FIG. 8 illustrates an explanatory diagram for describing an example of a waveform of an average signal;

FIG. 9 illustrates an explanatory diagram for describing an example of a waveform of a selection reference signal;

FIG. 10 illustrates an explanatory diagram for describing an example of a relation between a selection reference signal and respective absolute signals;

FIG. 11 illustrates an explanatory diagram for describing an example of control procedures that are related to a position data generation method of an encoder and that are executed by a controller;

FIG. 12 illustrates an explanatory diagram for describing an exemplary structure of a track according to a second embodiment;

FIG. 13 illustrates an explanatory diagram for describing an exemplary structure of an optical module according to the second embodiment;

FIG. 14 illustrates an explanatory diagram for describing an exemplary structure of a controller according to the second embodiment;

FIG. 15 illustrates an explanatory diagram for describing an example of a waveform of an average signal;

FIG. 16 illustrates an explanatory diagram for describing an example of a waveform of a selection reference signal;

FIG. 17 illustrates an explanatory diagram for describing an example of control procedures that are related to a position data generation method of an encoder and that are executed by a controller;

FIG. 18 illustrates an explanatory diagram for describing an exemplary structure of a track according to a third embodiment;

FIG. 19 illustrates an explanatory diagram for describing an exemplary structure of an optical module according to the third embodiment;

FIG. 20 illustrates an explanatory diagram for describing an exemplary structure of a controller according to the third embodiment;

FIG. 21 illustrates an explanatory diagram for describing an example of a waveform of a selection reference signal;

FIG. 22 illustrates an explanatory diagram for describing an example of control procedures that are related to a position data generation method of an encoder and that are executed by a controller;

FIG. 23 illustrates an explanatory diagram for describing an exemplary structure of an optical module according to a modified embodiment that illustrates another example of arrangement of light receiving arrays;

FIG. 24 illustrates an explanatory diagram for describing an exemplary structure of an optical module according to a modified embodiment that illustrates yet another example of arrangement of light receiving arrays;

FIG. 25 illustrates an explanatory diagram for describing an exemplary structure of an optical module according to a modified embodiment that illustrates yet another example of arrangement of light receiving arrays; and

FIG. 26 illustrates an explanatory diagram for describing a structural example of an encoder.

### DETAILED DESCRIPTION OF THE EMBODIMENTS

The embodiments will now be described with reference to the accompanying drawings, wherein like reference numerals designate corresponding or identical elements throughout the various drawings.

### First Embodiment

Servo System

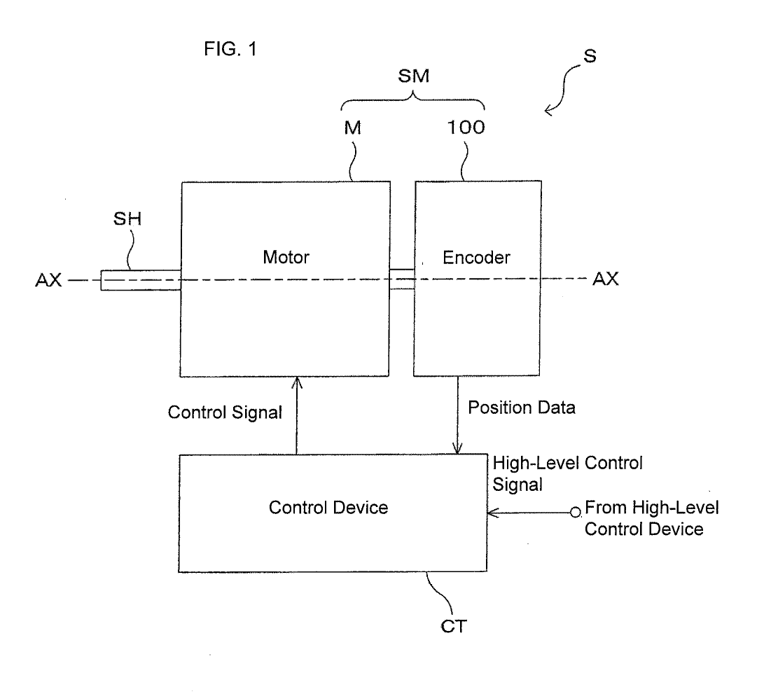

First, with reference to FIG. 1, an outline of an exemplary structure of a servo system according to the present embodiment is described.

As illustrated in FIG. 1, a servo system (S) includes a servo motor (SM) and a control device (CT). The servo motor (SM) includes a motor (M) and an encoder 100.

The motor (M) is an example of a power generation source that does not include the encoder 100. The motor (M) is provided with a rotor and a stator (both are not illustrated in the drawings). The rotor is a rotary motor that rotates with respect to the stator and outputs a torque by rotating a shaft (SH) that is fixed on the rotor about a rotation axis (AX). The motor (M) is not particularly limited as long as it is a motor that allows the encoder 100 to detect a position, a speed and the like.

Here, there are also cases where the motor (M) alone is referred to as a servo motor. However, in the present embodiment, a structure including the encoder 100 is referred to as the servo motor (SM). That is, the servo motor (SM) corresponds to an example of a motor with an encoder. For the convenience of description, in the following, a case is described where a motor with an encoder is a servo motor that is controlled so as to follow target values of a position, a speed, and the like. However, a motor with an encoder is not limited to such a case of being a servo motor. A motor with an encoder may be a motor that is used in a system other than a servo system as long as an encoder is attached, for example, in a case where a motor is used only for displaying an output of an encoder.

Further, the motor (M) is not limited to a case of an electric motor that uses electricity as a power source. For example, the motor (M) may also be a motor that uses another type of power source, such as a hydraulic motor, a pneumatic motor, a steam motor, or the like. However, for the convenience of the description, in the following, the case where the motor (M) is an electric motor is described.

The encoder 100 is connected to a side opposite to a torque output side of the shaft (SH). The connection position of the encoder 100 is not limited to the side opposite to the torque output side of the shaft (SH), but may also be on the torque output side of the shaft (SH). The encoder 100 detects a position (also referred to as a “rotation position,” a “rotation angle,” or the like) of the rotor of the motor (M) by detecting a position of the shaft (SH) and outputs position data that indicates the position. That is, the position data corresponds to an example of a detection result of the encoder.

The encoder 100 may also detect at least one of a speed (also referred to as a “rotational speed,” an “angular speed,” or the like) and an acceleration (also referred to as a “rotational acceleration,” an “angular acceleration,” or the like) of the rotor of the motor (M) in addition to or in place of the position of the rotor of the motor (M). In this case, the speed and acceleration of the rotor of the motor (M) can be detected by a process such as differentiating once or twice the position with respect to time or counting light receiving signals (such as the incremental signals) for a predetermined time period. However, for the convenience of the description, in the following, a case is described where a physical quantity that the encoder 100 detects is the position.

The control device (CT) acquires the position data from the encoder 100 and controls operation of the motor (M) based on the position data. Therefore, in the present embodiment in which an electric motor is used as the motor (M), the control device (CT) controls the operation of the motor (M) by controlling a current, a voltage, or the like, that is applied to the motor (M) based on the position data. Further, it is also possible that the control device (CT) acquires a high-level control signal from a high-level control device (not illustrated in the drawings) and controls the operation of the motor (M) in such a manner that a torque that allows a position or the like that is indicated by the high-level control signal to be realized is output from the shaft (SH). When the motor (M) uses another power source such as a hydraulic power source, a pneumatic power source or a steam power source, the control device (CT) can control the operation of the motor (M) by controlling supply of the power source.

Encoder

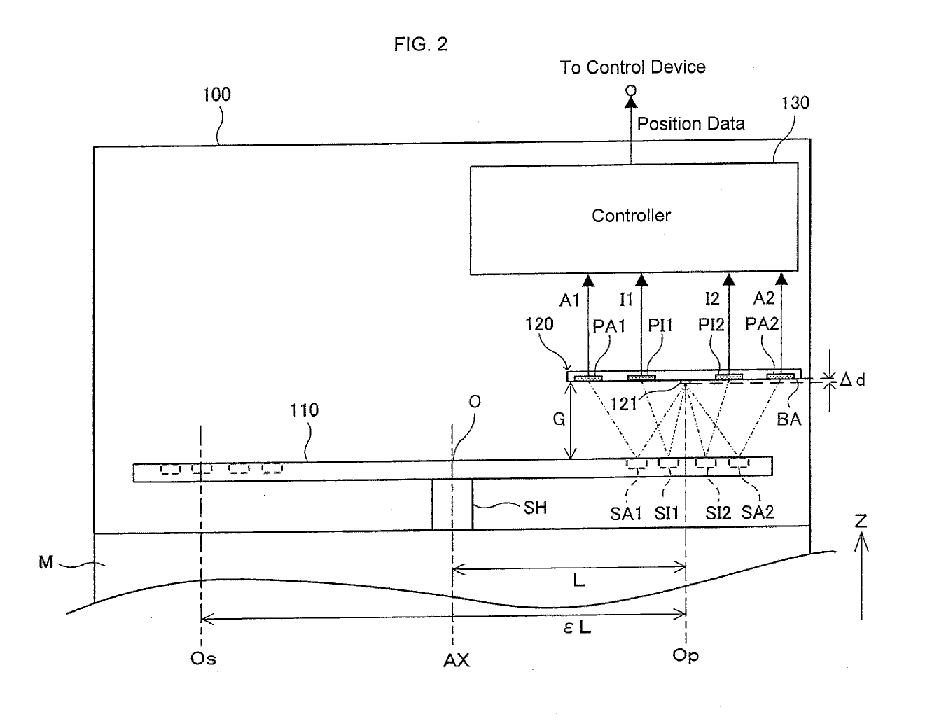

With reference to FIG. 2-6, an exemplary structure of the encoder 100 is described.

As illustrated in FIG. 2, the encoder 100 includes a disc 110, an optical module 120 and a controller 130.

For the convenience of the description of the configuration of the encoder 100, directions such as up, down, and the like, are defined as follows and used as appropriate. That is, a direction along which the disc 110 faces the optical module 120, that is, a positive direction of a Z-axis is defined as an “up” direction and a negative direction of the Z-axis is defined as a “down” direction. However, the up and down directions and the like vary depending on an installation mode of the encoder 100, and are not intended to limit a positional relation between the respective structural elements of the encoder 100.

Disc

As illustrated in FIG. 2-4, the disc 110 is formed in a shape of a circular plate and rotates with the rotation of the motor (M) by being fixed on the shaft (SH) in such a manner that a disc center (O) coincides with the rotation axis (AX). That is, the shaft (SH) corresponds to an example of a rotating body. In the present embodiment, an example is described in which the disc 110 is used as an example of an object to be measured for measuring a position of the motor (M). However, it is also possible that another member such as an end surface of the shaft (SH) is used as the object to be measured. Further, in an example illustrated in FIG. 2, the disc 110 is directly fixed on the shaft (SH). However, it is also possible that the disc 110 is connected to the shaft (SH) via a connecting member such as a hub.

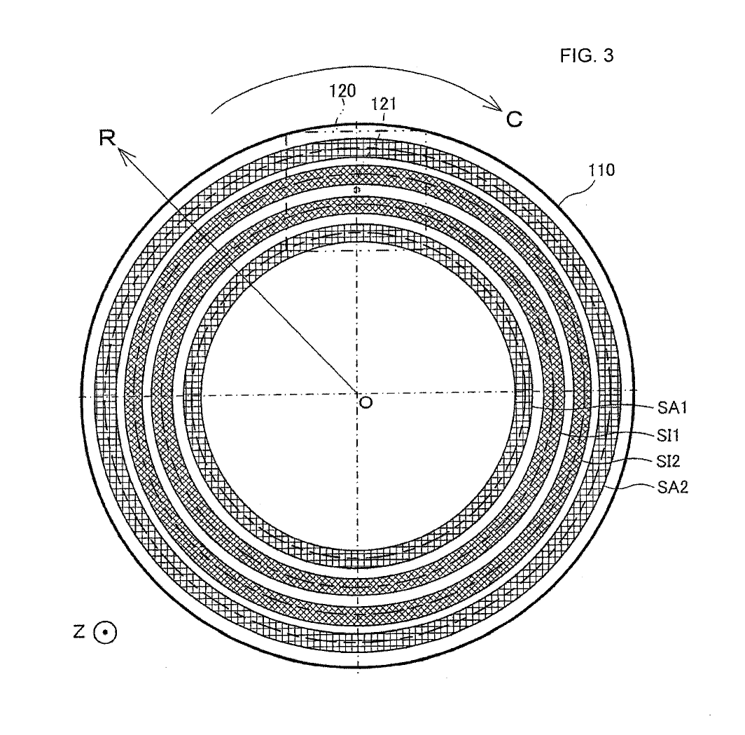

On an upper surface that is a surface of the disc 110 on a side opposing the optical module 120, multiple tracks are provided side by side in a width direction (which is a direction indicated by an arrow (R) in FIG. 3 and the like and will be referred to as the “width direction (R)” in the following), the tracks including multiple first tracks each of which has an incremental pattern (details of which will be described later) along a measurement direction (which is a direction indicated by an arrow (C) in FIG. 3 and the like and will be referred to as the “measurement direction (C)” in the following) and one or more second tracks each of which has an absolute pattern (details of which will be described later) along the measurement direction (C).

In the present embodiment, as the first tracks, two first tracks (SI1, SI2) are provided; and as the one or more second tracks, two second tracks (SA1, SA2) are provided. The number of the first tracks is not limited to two, but may be three or more. Similarly, the number of the second tracks is not limited to two, but may be one or three or more. However, for the convenience of the description, in the following, the case is described where the first tracks are the two first tracks (SI1, SI2) and the second tracks are the two second tracks (SA1, SA2). The tracks including the first tracks and the second tracks are concentrically arranged in an order of the second track (SA1), the first track (SI1), the first track (SI2) and the second track (SA2) from an inner side to an outer side in the width direction (R).

Here, the “measurement direction (C)” means a measurement direction when the tracks (SA1, SI1, SI2, SA2) are optically measured by the optical module 120. As in the present embodiment, in the rotary encoder 100 in which the object to be measured is the disc 110, the measurement direction (C) coincides with a circumferential direction around a central axis of the disc 110. The “central axis” means a rotation axis of the disc 110. In the case where the disc 110 and the shaft (SH) are coaxially connected, the central axis coincides with the rotation axis (AX) of the shaft (SH).

Further, the “width direction (R)” means a radial direction of the disc 110, that is, a direction perpendicular to the measurement direction (C). Lengths of the tracks (SA1, SI1, SI2, SA2) along the width direction (R) correspond to widths of the tracks (SA1, SI1, SI2, SA2).

Further, as described above, the disc 110 rotates with the rotation of the motor (M). However, as will be described later, the optical module 120 is fixed while opposing a portion of the tracks (SA1, SI1, SI2, SA2). Therefore, along with the rotation of the motor (M), the tracks (SA1, SI1, SI2, SA2) and the optical module 120 relatively move in the measurement direction (C) with respect to each other.

Optical Detection Mechanism

In the encoder 100, an optical detection mechanism that optically detects the rotation of the disc 110 is provided. The optical detection mechanism includes the tracks (SA1, SI1, SI2, SA2) and the optical module 120.

Tracks

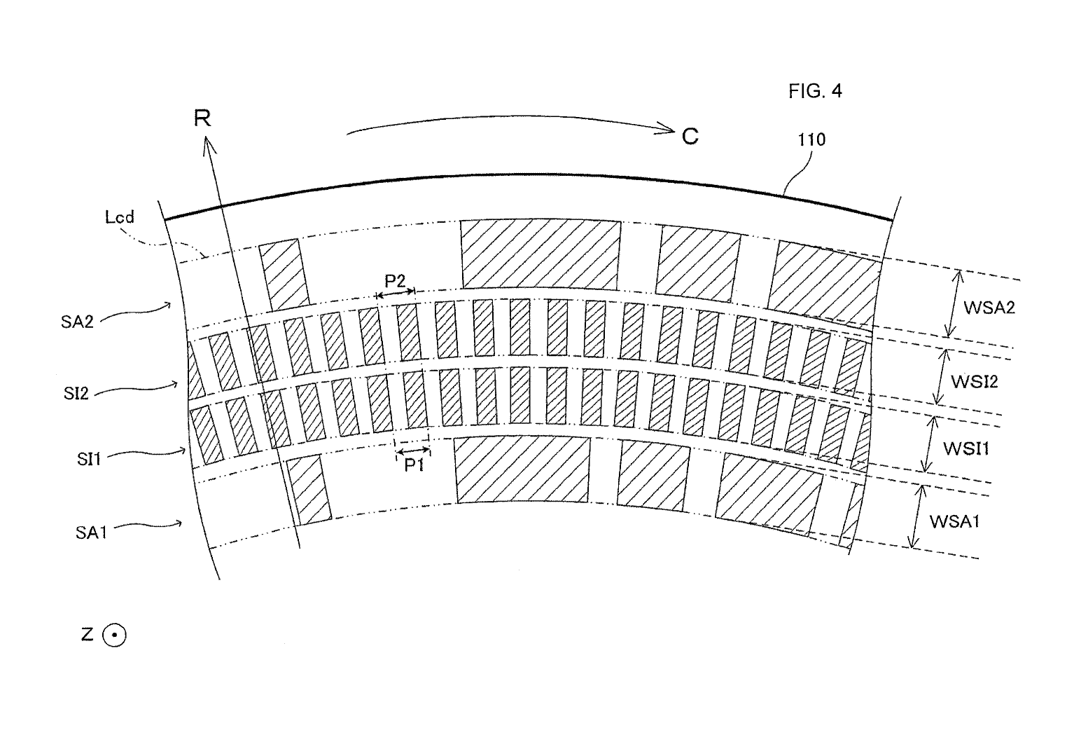

As illustrated in FIG. 2-4, the tracks (SA1, SI1, SI2, SA2) are each formed in a shape of a ring around the disc center (O) and each have multiple slits (oblique line hatched portions in FIG. 4) arranged over the entire circumference of the disc 110 along the measurement direction (C).

Here, the “slit” means a portion on the upper surface of the disc 110 that reflects (including reflective diffraction) or transmits (including transmissive diffraction) light emitted from a light source 121 (to be described later).

By arranging such slits along the measurement direction (C), the tracks (SA1, SI1, SI2, SA2) are formed. In the present embodiment, a case is described where the slits are each a reflection slit that reflects light emitted from the light source 121. However, it is also possible that the slits are each a transmission slit that transmits the light emitted from the light source 121.

That is, the tracks (SA1, SI1, SI2, SA2) each have multiple reflection slits arranged over the entire circumference of the disc 110 along the measurement direction (C), and each of the reflection slits reflects light emitted from the light source 121.

Here, the disc 110 is formed using a material such as metal that reflects light. By arranging, such as by coating, a material (such as chromium oxide) of low reflectance on portions that are not to reflect light on the upper surface of the disc 110, the reflection slits are formed at portions where the material is not arranged. It is also possible to form the reflection slits by subjecting the portions that are not to reflect light to sputtering and the like to thereby reduce the reflectance thereof as rough surface portions.

A material, a manufacturing method and the like of the disc 110 are not particularly limited. For example, it is possible to form the disc 110 using a material such as glass or transparent resin that transmits light. In this case, the reflection slits can be formed by arranging, such as by vapor deposition, a material (such as aluminum) that reflects light on the upper surface of the disc 110.

The reflection slits of each of the second tracks (SA1, SA2) are arranged over the entire circumference of the disc 110 having an absolute pattern along the measurement direction (C).

Here, the “absolute pattern” means a pattern in which a position, a proportion, and the like of a reflection slit within an angle to which a second light receiving array (to be described later) opposes are uniquely defined within one revolution of the disc 110. For example, in an example of an absolute pattern illustrated in FIG. 4, when the motor (M) is at a certain angular position, a bit pattern combination due to light reception or no light reception in multiple light receiving elements (to be described later) that the opposing second light receiving array has uniquely represents an absolute position of the angular position. The “absolute position” means an angular position relative to a point of origin within one revolution of the disc 110. The point of origin is set at an appropriate angular position within one revolution of the disc 110, and the absolute pattern is formed with the point of origin as a reference.

According to an example of the pattern, a pattern can be generated in which the absolute position is one-dimensionally represented by bits of the number of the light receiving elements of the opposing second light receiving array. However, the absolute pattern is not limited to this example. For example, the absolute pattern may also be a pattern that is multidimensionally represented by bits of the number of the light receiving elements of the opposing second light receiving array. Further, in addition to a predetermined bit pattern, various patterns are possible such as a pattern that varies in such a manner that physical quantities such as an intensity and a phase of light received by the light receiving elements of the opposing second light receiving array uniquely define the absolute position, and a pattern obtained by subjecting a code sequence of an absolute pattern to modulation.

In the present embodiment, two identical absolute patterns are arranged in the measurement direction (C) offset from each other by ½ a length of one bit and are formed as the second tracks (SA1, SA2). The offset amount corresponds to one half (=(P1)/2) of a pitch (P1) (to be described later) of the reflection slits of the first track (SI1). The offset amount is not necessarily required to be one half of the pitch (P1), but may take various values.

Suppose such a structure in which the second tracks (SA1, SA2) are arranged offset from each other in the measurement direction (C) is not adopted, the following is possible. That is, when an absolute position is represented by an one-dimensional absolute pattern as in the present embodiment, in a transition region of a bit pattern due to that the light receiving elements of the two second light receiving arrays corresponding to the second tracks (SA1, SA2) are positioned opposing a vicinity of an end of a reflection slit, there is a possibility that detection accuracy of the absolute position decreases.

In the present embodiment, by arranging the second tracks (SA1, SA2) offset from each other in the measurement direction (C), for example, when an absolute position according to the second track (SA1) corresponds to a transition region of a bit pattern, a light receiving signal from the second light receiving array corresponding to the second track (SA2) is used to calculate an absolute position, and vice versa. Thereby, the detection accuracy of the absolute position can be improved. When such a structure is adopted, it is necessary to equalize amounts of light received by the two second light receiving arrays corresponding to the second tracks (SA1, SA2). However, in the present embodiment, as will described later, the two second light receiving arrays corresponding to the second tracks (SA1, SA2) are arranged at equal distances from the light source 121. Therefore, the above structure can be realized.

Instead of arranging the absolute patterns of the second tracks (SA1, SA2) offset from each other in the measurement direction (C), it is also possible that the second light receiving arrays corresponding to the second tracks (SA1, SA2) are arranged offset from each other in the measurement direction (C).

On the other hand, the reflection slits of each of the first tracks (SI1, SI2) are arranged over the entire circumference of the disc 110 having an incremental pattern along the measurement direction (C).

Here, the “incremental pattern” means that a pattern that is regularly repeated at a predetermined pitch. Here, the “pitch” means an arrangement interval of the reflection slits of the first tracks (SI1, SI2) having an incremental pattern. The pitch of the reflection slits of the first track (SI1) is P1, and the pitch of the reflection slits of the first track (SI2) is P2. Unlike the absolute pattern in which presence or absence of light reception by each of the light receiving elements is used as a bit to represent the absolute position, the incremental pattern uses a sum of light receiving signals of one or more light receiving elements to represent a position of the motor (M) of each one pitch or within one pitch. Therefore, the incremental pattern does not represent an absolute position, but can represent a position with very high accuracy as compared to the absolute pattern.

In the present embodiment, the pitches (P1, P2) are set to be the same. That is, the pitches are set so that P1=P2. Therefore, the number of the reflection slits of the first track (SI1) and the number of the reflection slits of the first track (SI2) are the same. A relation between the pitches is not necessarily required to be that the pitches are set to be the same. Various kinds of relations between the pitches are possible such as that one pitch is set be two times, three times, four times or five times of the other pitch, and the like.

In the present embodiment, a minimum length of the reflection slits of the second tracks (SA1, SA2) in the measurement direction (C) coincides with the pitches (P1, P2). As a result, a resolution of a light receiving signal of the second light receiving arrays corresponding to the second tracks (SA1, SA2) coincides with the number of the reflection slits of the first tracks (SI1, SI2). The minimum length is not necessarily required to coincide with the pitches (P1, P2). It is desirable that the number of the reflection slits of the first tracks (SI1, SI2) be formed the same as or more than the resolution of the light receiving signal of the second light receiving arrays corresponding to the second tracks (SA1, SA2).

Further, lengths of the reflection slits of the second tracks (SA1, SA2) in the measurement direction (C) coincide with integer multiples of the pitches (P1, P2). The lengths are not necessarily required to be integer multiples of the pitches (P1, P2).

Further, a position of an end corresponding to the measurement direction (C) of each of the reflection slits of the second track (SA1) is offset from a position of an end corresponding to the measurement direction (C) of a reflection slit of the first track (SI1) to one side of the measurement direction (C). The offset amount corresponds to one quarter of the pitch (P1)(=(P1)/4). Similarly, a position of an end corresponding to the measurement direction (C) of each of the reflection slits of the second track (SA2) is offset from a position of an end corresponding to the measurement direction (C) of a reflection slit of the first track (SI1) to the other side of the measurement direction (C). The offset amount corresponds to one quarter of the pitch (P1). The offset amount is not necessarily required to be one quarter of the pitch (P1), but may take various values. Further, the end corresponding to the measurement direction (C) of the each of the reflection slits of the second tracks (SA1, SA2) and the end corresponding to the measurement direction (C) of the reflection slit of the first track (SI1) are not necessarily required to be offset in the measurement direction (C), but a case where the two are not offset in the measurement direction (C) is also possible.

Optical Module

As illustrated in FIGS. 2, 3 and 5, the optical module 120 is formed as one sheet of a substrate (BA) parallel to the disc 110. As a result, the encoder 100 can be made thin, and the optical module 120 can be easily manufactured. The optical module 120 is fixed in a manner opposing a portion of the tracks (SA1, SI1, SI2, SA2). Therefore, along with the rotation of the disc 110, the optical module 120 relatively moves with respect to the tracks (SA1, SI1, SI2, SA2) in the measurement direction (C). The optical module 120 is not necessarily required to be formed as one sheet of the substrate (BA). It is also possible that the respective structures are formed as multiple substrates. In this case, these substrates may be integrally arranged. Further, it is also possible that the optical module 120 is not in a shape of a substrate.

On a lower surface that is a surface of the substrate (BA) on a side opposing the disc 110, the light source 121 is provided. Further, on the lower surface of the substrate (BA), multiple light receiving arrays including multiple first light receiving arrays that correspond to the first tracks and two second light receiving arrays that correspond to the second tracks are provided side by side in the width direction (R). In this case, the first light receiving arrays are arranged at mutually offset positions in the width direction (R).

In the present embodiment, as the first light receiving arrays, two first light receiving arrays (PI1, PI2) are provided; and as the two second light receiving arrays, two second light receiving arrays (PA1, PA2) are provided. The light receiving arrays including the first light receiving arrays and the second light receiving arrays are concentrically arranged in an order of the second light receiving array (PA1), the first light receiving array (PI1), the first light receiving array (PI2) and the second light receiving array (PA2) from an inner side to an outer side in the width direction (R).

Light Source

The light source 121 is arranged, for example, at a center of the substrate (BA) and emits light to a portion (hereinafter, also referred to as an “irradiation area”) of the tracks (SA1, SI1, SI2, SA2) of the disc 110 that passes through a position opposing the optical module 120.

The light source 121 is not particularly limited as long as it is a light source capable of emitting light to the irradiation area. For example, as the light source 121, an LED (Light Emitting Diode) can be used. In the present embodiment, the light source 121 is structured as a point light source in which an optical lens or the like is not particularly arranged, and diffused light is emitted from a light emitting part. The “point light source” is not necessary to be strictly a point. Light may be emitted from a finite surface as long as the light source can be regarded as a light source that emits diffused light from a substantially point-like position from a viewpoint of design and operating principle. Further, the “diffused light” is not limited to light that is omnidirectionally emitted from a point light source, but also includes light that is emitted toward a certain finite range of directions while being diffused. That is, as long as light is more diffusive than parallel light, the light is included in the diffused light as referred to here. In this way, by using a point light source, although being affected to some extent by factors such as light intensity variation due to deviation from an optical axis and attenuation due to a difference in optical path length, the light source 121 can emit diffused light to the irradiation area and can evenly emit light to the irradiation area. Further, light condensing and diffusion using an optical element are not performed. Therefore, an error or the like due to the optical element is less likely to occur, and rectilinearity of light emitted toward the irradiation area can be improved.

Light Receiving Array

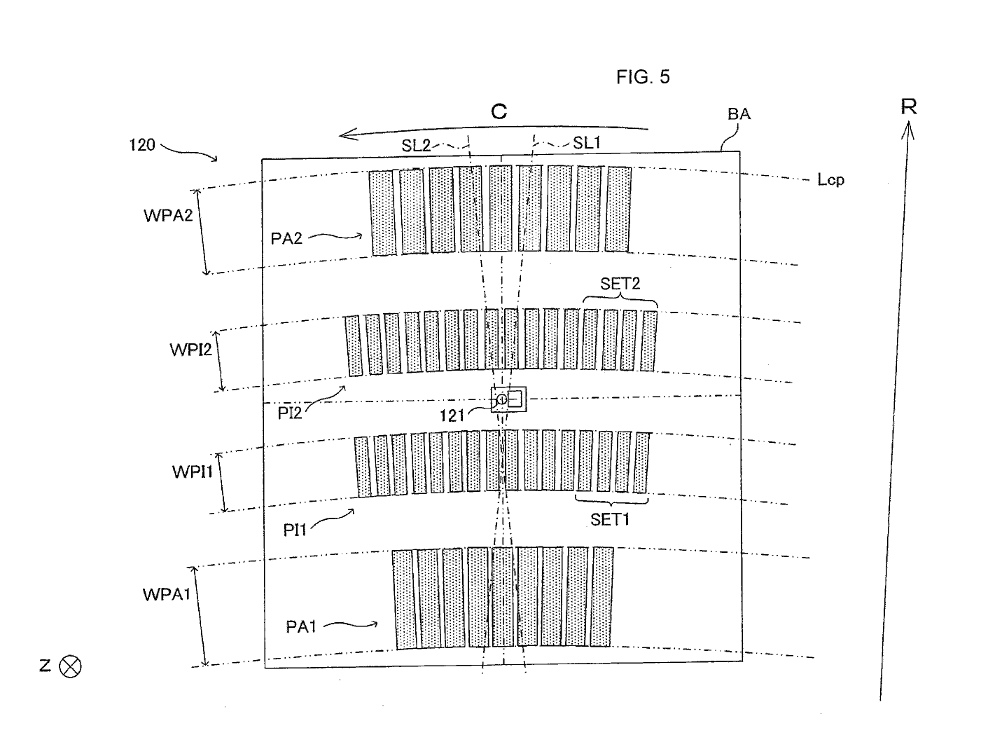

The light receiving arrays (PA1, PI1, PI2, PA2) are arranged around the light source 121 and have multiple light receiving elements (dot hatched portions in FIG. 5) that respectively receive light reflected by the reflection slits of the corresponding tracks to output light receiving signals. The light receiving elements of the light receiving arrays (PA1, PI1, PI2, PA2) are arranged at a certain pitch along the measurement direction (C).

Each of the light receiving elements is not particularly limited as long as the light receiving element can receive light that is emitted from the light source 121 and reflected by the reflection slits and convert the light to a light receiving signal. However, for example, a photodiode can be used as the light receiving element.

The light emitted from the light source 121 is diffused light. Therefore, images of the tracks (SA1, SI1, SI2, SA2) projected onto the optical module 120 are enlarged by a predetermined enlargement ratio (ε) corresponding to an optical path length. That is, when lengths of the tracks (SA1, SI1, SI2, SA2) in the width direction (R) are WSA1, WSI1, WSI2 and WSA2, and lengths of shapes projected onto the optical module 120 by light reflected by the tracks (SA1, SI1, SI2, SA2) in the width direction (R) are WPA1, WPI1, WPI2 and WPA2, WPA1, WPI1, WPI2 and WPA2 are respectively E times of WSA1, WSI1, WSI2 and WSA2. In the present embodiment, an example is illustrated in which the lengths of the light receiving elements of the light receiving arrays (PA1, PI1, PI2, PA2) in the width direction (R) are set to equal to those of the shapes projected onto the optical module 120 by the reflection slits of the tracks (SA1, SI1, SI2, SA2). However, the lengths of the light receiving elements of the light receiving arrays (PA1, PI1, PI2, PA2) in the width direction (R) are not necessarily limited to this example. It is also possible that, for example, for the light receiving arrays (PA1, PA2), the lengths of the light receiving elements in the width direction (R) are different.

Similarly, the measurement direction (C) on the optical module 120 is also a shape projected onto the optical module 120 by the measurement direction (C) on the disc 110, that is, a shape affected by the enlargement ratio (ε). To make understanding easy, the measurement direction (C) at the position of the light source 121 illustrated in FIG. 2 is described in detail as an example. That is, the measurement direction (C) of the disc 110 is in a circular shape centered on the rotation axis (AX) (the disc center O). In contrast, a center of the measurement direction (C) projected onto the optical module 120 is at a position that is separated by a distance (εL) from an optical center (Op), which is a position on the surface of the disc 110 where the light source 121 is arranged. The distance (εL) is a distance obtained by enlarging a distance L between the rotation axis (AX) and the optical center (Op) by the enlargement ratio (ε). This position is schematically illustrated as a measurement center (Os) in FIG. 2. Therefore, the measurement direction (C) on the optical module 120 is on a line having the distance (εL) as a radius and the measurement center (Os) as a center, the measurement center (Os) being separated by the distance (εL) from the optical center (Op) in a direction toward the rotation axis (AX) on a line passing through the optical center (Op) and the rotation axis (AX).

In FIGS. 4 and 5, a correspondence relationship between the respective measurement directions (C) of the disc 110 and the optical module 120 is expressed using arc-shaped lines (Lcd, Lcp). The line (Lcd) illustrated in FIG. 4 represents a line along the measurement direction (C) of the disc 110, and the line (Lcp) illustrated in FIG. 5 represents a line along the measurement direction (C) of the substrate (BA) (a line projected onto the optical module 120 by the line (Lcd)).

Further, when a gap length between the optical module 120 and the disc 110 is G and a protrusion amount of the light source 121 from the substrate (BA) is Δd, the enlargement ratio (ε) is represented by the following Formula 1.

ε=(2G−Δd)/(G−Δd) Formula 1

Further, the light receiving arrays (PA1, PI1, PI2, PA2) are arranged in correspondence to the tracks (SA1, SI1, SI2, SA2). That is, the first light receiving array (PI1) is arranged in correspondence to the first track (SI1). The light receiving elements of the first light receiving array (PI1) receive light reflected by the reflection slits of the first track (SI1) to output a light receiving signal. Further, the first light receiving array (PI2) is arranged in correspondence to the first track (SI2). The light receiving elements of the first light receiving array (PI2) receive light reflected by the reflection slits of the first track (SI2) to output a light receiving signal. Further, the second light receiving array (PA1) is arranged in correspondence to the second track (SA1). The light receiving elements of the second light receiving array (PA1) receive light reflected by the reflection slits of the second track (SA1) to output a light receiving signal. Further, the second light receiving array (PA2) is arranged in correspondence to the second track (SA2). The light receiving elements of the second light receiving array (PA2) receive light reflected by the reflection slits of the second track (SA2) to output a light receiving signal.

The second light receiving arrays (PA1, PA2) are arranged sandwiching the light source 121 therebetween in the width direction (R). In this example, the second light receiving array (PA1) is arranged on an inner side in the width direction (R), and the second light receiving array (PA2) is arranged on an outer side in the width direction (R). In this case, the second light receiving arrays (PA1, PA2) are arranged to be symmetrical in the width direction (R) about the light source 121. The second light receiving arrays (PA1, PA2) may also be arranged to be asymmetric in the width direction (R) about the light source 121. However, for the convenience of the description, in the following, the case is described where the second light receiving arrays (PA1, PA2) are arranged to be symmetrical in the width direction (R) about the light source 121. Therefore, a distance between the second light receiving array (PA1) and the light source 121 and a distance between the second light receiving array (PA2) and the light source 121 are equal. That is, the second light receiving arrays (PA1, PA2) (except curved shapes centered on the measurement center (Os)) are basically formed in line-symmetric shapes with lines passing through the light source 121 along the width direction (R) and along the measurement direction (C) as axes of symmetry.

Further, in the second light receiving arrays (PA1, PA2), by receiving light reflected by the corresponding second tracks (SA1, SA2), a light receiving signal having a bit pattern of the number of the light receiving elements (nine in the example illustrated in FIG. 5) is output. That is, the light receiving signal from the second light receiving arrays (PA1, PA2) having the bit pattern of the number of the light receiving elements corresponds to an example of a second light receiving signal. The light receiving signal from the second light receiving arrays (PA1, PA2) having the bit pattern of the number of the light receiving elements is also referred to as the “absolute signal.” Further, the absolute signal from the second light receiving array (PA1) is also referred to as an “absolute signal (A1),” and the absolute signal from the second light receiving array (PA2) is also referred to as an “absolute signal (A2).” As described above, the absolute patterns of the second tracks (SA1, SA2) are arranged by being mutually offset by a ½ length of one bit in the measurement direction (C). Therefore, the absolute signals (A1, A2) are different from each other by a phase of 180 degrees.

Further, in the present embodiment, as described above, a one-dimensional pattern as the absolute pattern is illustrated. In each of the light receiving elements of the second light receiving arrays (PA1, PA2), light reception or no light reception is treated as a bit. By the bits of the number of the light receiving elements of the second light receiving arrays (PA1, PA2), the absolute position is represented. Therefore, the light receiving signals of the light receiving elements of the second light receiving arrays (PA1, PA2) are treated independently from each other by the controller 130, and thereby, an absolute position that has been encrypted (encoded) into a serial bit pattern is decoded from a combination of the light receiving signals. When an absolute pattern different from that of the present embodiment is used, the light receiving arrays (PA1, PA2) adopt a structure correspond to the pattern.

On the other hand, as described above, the first light receiving arrays (PI1, PI2) are arranged at mutually offset positions in the width direction (R). In this case, the first light receiving arrays (PI1, PI2) are arranged on an inner side of the second light receiving arrays (PA1, PA2) in the width direction (R). In this example, the first light receiving array (PI1) is arranged on an inner side in the width direction (R), and the first light receiving array (PI2) is arranged on an outer side in the width direction (R). Specifically, the first light receiving arrays (PI1, PI2) are arranged sandwiching the light source 121 therebetween on the inner side of the second light receiving arrays (PA1, PA2) in the width direction (R). That is, the first light receiving array (PI1) is arranged between the light receiving array (PA1) and the light source 121 in the width direction (R), and the first light receiving array (PI2) is arranged between the light source 121 and the light receiving array (PA2) in the width direction (R). In this case, the first light receiving arrays (PI1, PI2) are arranged to be symmetrical in the width direction (R) about the light source 121. The first light receiving arrays (PI1, PI2) may also be arranged to be asymmetrical in the width direction (R) about the light source 121. However, for the convenience of the description, in the following, the case is described where the first light receiving arrays (PI1, PI2) are arranged to be symmetrical in the width direction (R) about the light source 121. Therefore, a distance between the first light receiving array (PI1) and the light source 121 and a distance between the first light receiving array (PI2) and the light source 121 are equal. That is, the first light receiving arrays (PI1, PI2) (except curved shapes centered on the measurement center (Os)) are basically formed in line-symmetric shapes with lines passing through the light source 121 along the width direction (R) and along the measurement direction (C) as axes of symmetry.

Further, in the first light receiving arrays (PI1, PI2), by receiving light reflected by the corresponding first tracks (SI1, SI2), a light receiving signal is output. That is, the light receiving signal from the first light receiving arrays (PI1, PI2) corresponds to an example of a first light receiving signal.

First, the first light receiving array (PI1) is described as an example. That is, in the present embodiment, in one pitch of the first track (SI1) (one pitch in a projected image, that is, ε×P1), a set (indicated by “SET1” in FIG. 5) of a total of four light receiving elements is arranged, and multiple sets each including four light receiving elements are further arranged along the measurement direction (C). In the incremental pattern, a reflection slit is repeated formed for each one pitch. Therefore, when the disc 110 rotates, each light receiving element in one pitch generates one period (referred to as 360 degrees in an electrical angle) worth of a periodic light receiving signal. Therefore, four light receiving elements are arranged in one set corresponding to one pitch. Thus, the four light receiving elements adjacent to each other in one set generate periodic light receiving signals having 90-degree phase differences between each other. Further, the incremental pattern represents a position within one pitch. Therefore, the light receiving signals of the respective phases in one set and corresponding light receiving signals of the respective phases in another set have similarly varying values. Therefore, light receiving signals of the same phase are summed over multiple sets. Therefore, from a large number of light receiving elements of the first light receiving array (PI1), four light receiving signals of which the phases are shifted by 90 degrees from each other are generated.

On the other hand, the first light receiving array (PI2) is also structured similar to the first light receiving array (PI1). That is, in one pitch of the first track (SI2) (one pitch in a projected image, that is, ε×P2), a set (indicated by “SET2” in FIG. 5) of a total of four light receiving elements is arranged, and multiple sets each including four light receiving elements are further arranged along the measurement direction (C). Therefore, from a large number of light receiving elements of the first light receiving array (PI2), four light receiving signals of which the phases are shifted by 90 degrees from each other are generated.

As described above, in each of the first light receiving arrays (PI1, PI2), four light receiving signals of which the phases are shifted by 90 degrees from each other are generated. These light receiving signals are also referred to as “incremental signals.” Further, these light receiving signals are also respectively referred to as an “A phase signal,” a “B phase signal” (having a phase difference of 90 degrees with respect to the A phase signal), an “A bar phase signal” (having a phase difference of 180 degrees with respect to the A phase signal) and a “B bar phase signal” (having a phase difference of 180 degrees with respect to the B phase signal). For the convenience of the description, in the following, the four incremental signals of which the phases are shifted by 90 degrees from each other that are output from the first light receiving array (PI1) may also be collectively referred to as “one incremental signal.” Similarly, the four incremental signals of which the phases are shifted by 90 degrees from each other that are output from the first light receiving array (PI2) may also be collectively referred to as “one incremental signal.” The incremental signal from the first light receiving array (PI1) is also referred to as an “incremental signal (I1),” and the incremental signal from the first light receiving array (PI2) is also referred to as an “incremental signal (12).”

In the present embodiment, a case is described where four light receiving elements are included in one set corresponding to one pitch of the incremental pattern. However, the number of the light receiving elements included in one set is not particularly limited. For example, it is also possible that two light receiving elements are included in one set.

Controller

As illustrated in FIG. 2, the controller 130 acquires the incremental signals (I1, I2) from the first light receiving arrays (PI1, PI2) and the absolute signals (A1, A2) from the second light receiving arrays (PA1, PA2), at a timing when the absolute position (also referred to as a “first absolute position”) in the resolution of the absolute signals (A1, A2) is measured (for example, when the encoder 100 is turned on or at a suitable timing after the start of the rotation of the motor (M)). Then, the controller 130 identifies the first absolute position based on one of the acquired absolute signals (A1, A2). Thereafter, based on the above identified first absolute position and one or more of the incremental signals (I1, 12), the controller 130 calculates an absolute position (which is also referred to as a “second absolute position”) of a resolution higher than the resolution of the absolute signals (A1, A2), generates position data representing the second absolute position and outputs the position data to the control device (CT).

After the first absolute position is measured (for example, after the start of the rotation of the motor (M)), the controller 130 generates position data based on the above identified first absolute position and one or more of the incremental signals (I1, I2), and outputs the position data to the control device (CT).

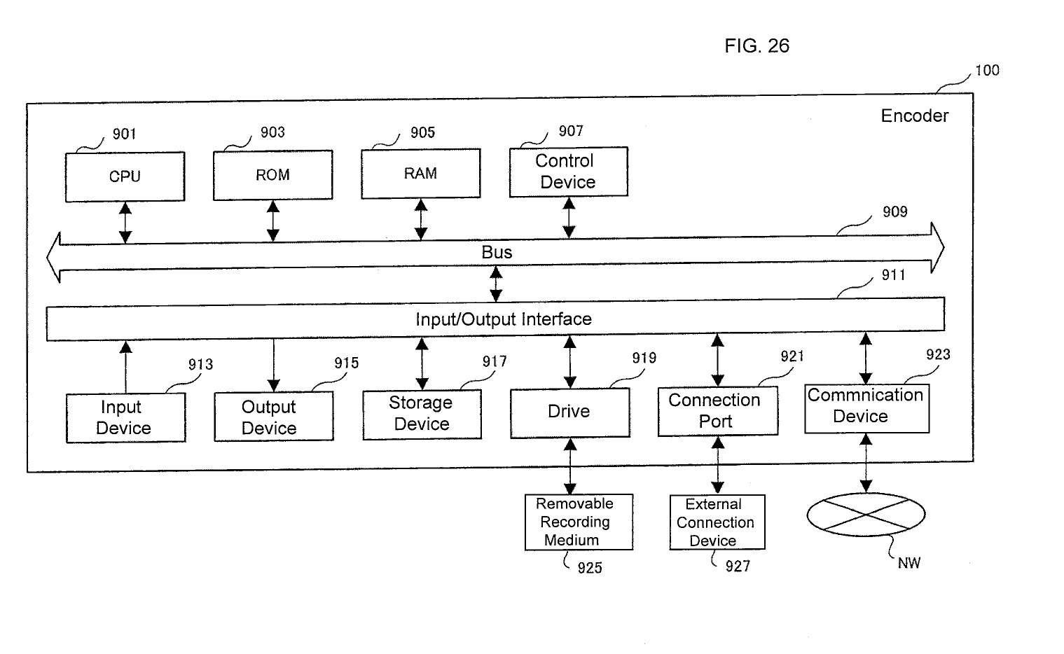

Such a controller 130 is implemented by at least one of a program that is executed by a CPU 901 (see FIG. 26 to be described later) that is provided in the encoder 100 and a control device 907 (see FIG. 26 to be described later) such as an application specific integrated circuit (such as an ASIC or an FPGA that is built for a specific application) or another electrical circuit that is provided in the encoder 100. That is, the control device 907 corresponds to an example of an encoder control device.

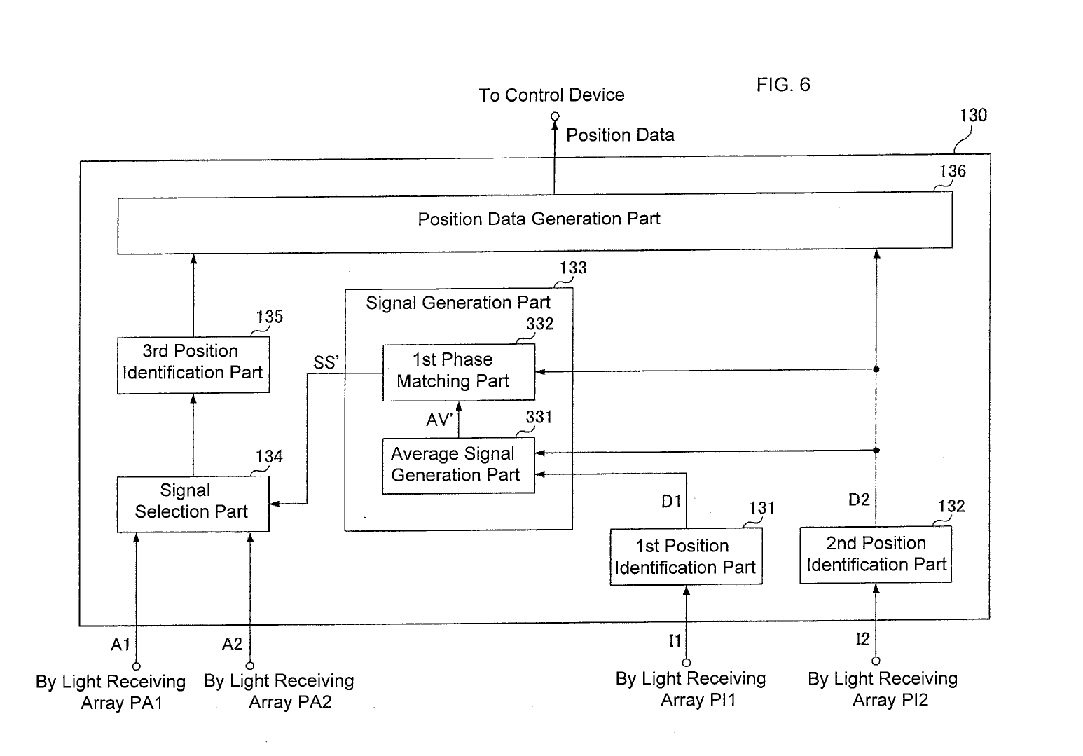

In the following, with reference to FIG. 6, with respect to an exemplary structure of the controller 130, an example of implementation using more specific functional blocks is described.

As illustrated in FIG. 6, the controller 130 includes a first position identification part 131, a second position identification part 132, a third position identification part 135, and a position data generation part 136.

The first position identification part 131 acquires from the first light receiving array (PI1) four incremental signals (one incremental signal (I1)) of which the phases are shifted by 90 degrees from each other, and performs subtraction between incremental signals that are different by 180 degrees in phase from each other among the four incremental signals. In this way, by performing subtraction between the incremental signals that are different by 180 degrees in phase from each other, manufacturing error or measurement error of the reflection slit within one pitch of the first track (SI1) can be canceled. Two signals as results of the above subtraction are referred to as a “first incremental signal” and a “second incremental signal” in the following. These first incremental signal and second incremental signal are different from each other in phase by 90 degrees in the electrical angle. Then, the first position identification part 131, based on the first incremental signal and the second incremental signal, identifies a position (electrical angle) within one pitch of the first track (SI1) and generates and outputs first data representing the position.

The identification method of the position within one pitch is not particularly limited. For example, when the incremental signal is sine wave signal, as the identification method, there is a method in which, by operating arctan on a result of division between the first incremental signal and the second incremental signal, an electrical angle is calculated. Further, as the identification method, there is a method in which a tracking circuit is used to convert the first incremental signal and the second incremental signal to an electrical angle. Further, as the identification method, there is a method in which an electrical angle associated with values of the first incremental signal and the second incremental signal is identified in a table that is created in advance. In this case, it is preferable that the first position identification part 131 performs analog-to-digital conversion with respect to each of the first incremental signal and the second incremental signal.

Further, the first data that the first position identification part 131 outputs may be the above-generated first data itself. However, in the following, a case is described where the first data that the first position identification part 131 outputs is first data (D1) obtained after the above-generated first data is subjected to a multiplication process. In this case, a multiplication number of the first data is not particularly limited. However, in the following, a case is described where the multiplication number of the first data is 2ⁿ (where n is an integer equal to or greater than 1). That is, the first position identification part 131 subjects the above-generated first data to a multiplication process in which the multiplication number is 2ⁿ, and outputs the first data (D1) after the multiplication process. The first data (D1) is a periodic signal representing a position within one pitch of the first track (SI1).

The second position identification part 132 acquires from the first light receiving array (PI2) four incremental signals (one incremental signal (I2)) of which the phases are shifted by 90 degrees from each other. Then, the second position identification part 132 performs processing similar to the first position identification part 131, identifies a position (electrical angle) within one pitch of the first track (SI2), and generates and outputs second data representing the position.

The second data that the second position identification part 132 outputs may be the above-generated second data itself However, in the following, a case is described where the second data that the second position identification part 132 outputs is second data (D2) obtained after the above-generated second data is subjected to a multiplication process. In this case, a multiplication number of the second data is not particularly limited. However, in the following, a case is described where the multiplication number of the second data is 2ⁿ, and the resolution of the first data after the multiplication process and the resolution of the second data after the multiplication process are the same. That is, the second position identification part 132 subjects the above-generated second data to a multiplication process in which the multiplication number is 2ⁿ, and outputs the second data (D2) after the multiplication process. The second data (D2) is a periodic signal representing a position within one pitch of the first track (SI2).

The third position identification part 135 binarizes one of the absolute signals (A1, A2) and converts the result to bit data representing an absolute position. Then, the third position identification part 135, based on a correspondence relationship between predetermined bit data and the absolute position, identifies the first absolute position and outputs third data representing the first absolute position to the position data generation part 136.

The position data generation part 136, based on one of the absolute signals (A1, A2) and one or more of the incremental signals (I1, I2), calculates the second absolute position, and generates and outputs the position data to the control device (CT). That is, the position data generation part 136 corresponds to an example of a means that generates position data.

The generation method of the position data by the position data generation part 136 is not particularly limited as long as it is a method that uses one of the absolute signals (A1, A2) and one or more of the incremental signals (I1, I2). However, for the convenience of the description, in the following, a case is described where the generation method of the position data by the position data generation part 136 is a method that uses the third data due to the third position identification part 135 and at least one of the first data (D1) due to the first position identification part 131 and the second data (D2) due to the second position identification part 132.

That is, the position data generation part 136 calculates the second absolute position and generates the position data, based on the third data and at least one of the first data (D1) and the second data (D2).

Here, in the present embodiment, the absolute signal that is used when the third position identification part 135 generates the third data is one of the absolute signals (A1, A2) that is selected based on the incremental signals (I1, I2). Therefore, the position data generation part 136 calculates the second absolute position and generates the position data, based on the third data and at least one of the first data (D1) and the second data (D2), the third data being based on one of the absolute signals (A1, A2) that is selected based on the incremental signals (I1, I2). In the following, an example of the generation method of the position data by the position data generation part 136 is described.

That is, the position data generation part 136 acquires the third data from the third position identification part 135 and acquires the second data (D2) from the second position identification part 132, and, by superimposing the second data (D2) (relative position) on the third data (first absolute position), calculates the second absolute position, which is higher in resolution than the first absolute position, and generates the position data. In this case, the position data generation part 136 may use the first data (D1) from the first position identification part 131 in place of or in addition to the second data (D2).

Here, as described above, the absolute signal that is used by the third position identification part 135 is one of the absolute signals (A1, A2) that is selected based on the incremental signals (I1, I2). In the following, this is described in detail.

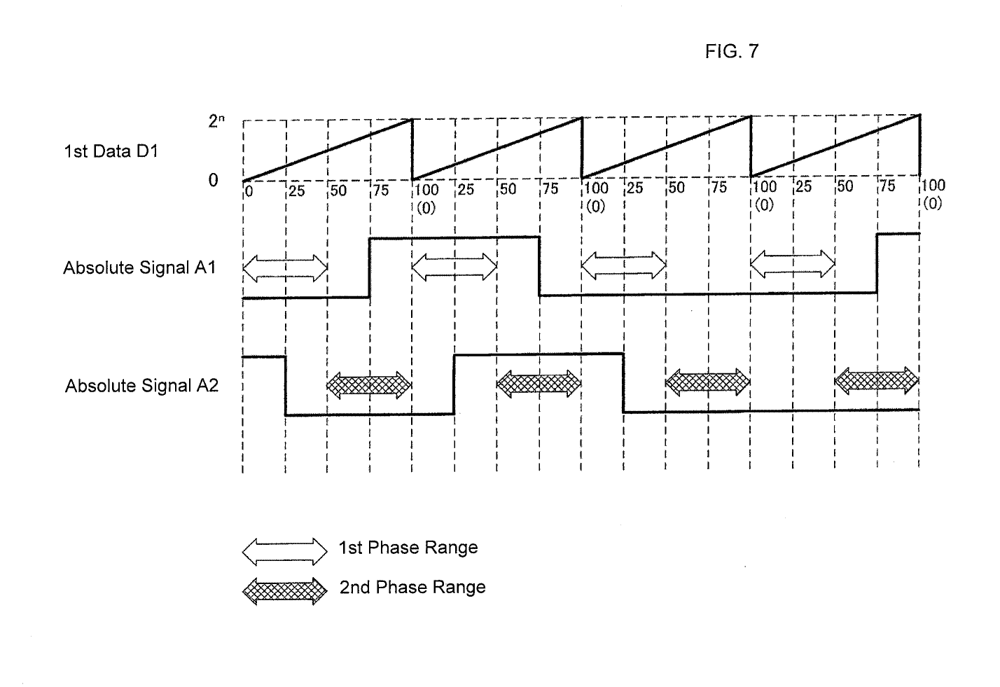

First, with reference to FIG. 7, a case is described where there exists no eccentricity between the disc 110 and the shaft (SH) and the optical module 120 is not arranged tilted in a rotation direction.

In FIG. 7, a saw-tooth waveform of an upper row is a waveform of the first data (D1). A number in the waveform represents a size of a phase in a case where one period (360 degrees in electrical angle) is 100%. In FIG. 7, a sloped part of the waveform of the first data (D1) is illustrated in a linear shape. However, in practice, the sloped part changes stepwise. A pulse waveform of a middle row is a waveform of the absolute signal (A1). A pulse waveform of a lower row is a waveform of the absolute signal (A2).

As described above, a position of an end corresponding to the measurement direction (C) of each of the reflection slits of the second track (SA1) is offset from a position of an end corresponding to the measurement direction (C) of a reflection slit of the first track (SI1) by one quarter of the pitch (P1) to one side of the measurement direction (C). Similarly, a position of an end corresponding to the measurement direction (C) of each of the reflection slits of the second track (SA2) is offset from a position of an end corresponding to the measurement direction (C) of a reflection slit of the first track (SI1) by one quarter of the pitch (P1) to the other side of the measurement direction (C). Further, the lengths of the reflection slits of the second tracks (SA1, SA2) in the measurement direction (C) coincide with integer multiples of the pitches (P1, P2).

Therefore, as illustrated in FIG. 7, the waveform of the absolute signal (A1) has an On-Off transition when the phase of the first data (D1) is 75%, and the waveform of the absolute signal (A2) has an On-Off transition when the phase of the first data (D1) is 25%.

That is, in a phase range (phase range indicated by a white double-headed arrow) where the phase of the first data (D1) is 0-50%, an amplitude of the absolute signal (A1) is more stable than that of the absolute signal (A2). In the following, this phase range is also referred to as a “first phase range.” On the other hand, in a phase range (phase range indicated by a cross-hatched double-headed arrow) where the phase of the first data (D1) is 50-100%, the amplitude of the absolute signal (A2) is more stable than that of the absolute signal (A1). In the following, this phase range is also referred to as a “second phase range.”

Therefore, as described above, in the case where there exists no eccentricity between the disc 110 and the shaft (SH) and the optical module 120 is not arranged tilted in the rotation direction, when the phase of the first data (D1) is in the first phase range, the absolute signal (A1) can be selected as an absolute position identification absolute signal. On the other hand, when the phase of the first data (D1) is in the second phase range, the absolute signal (A2) can be selected as the absolute position identification absolute signal. As a result, the absolute position can be identified using an absolute signal that is not in a region such as a changing point of a detection pattern where the amplitude of the detection pattern is unstable. Therefore, the detection accuracy can be improved.

Next, a case is described where eccentricity exists between the disc 110 and the shaft (SH), or the optical module 120 is arranged tilted in the rotation direction, or both the eccentricity exists between the disc 110 and the shaft (SH) and the optical module 120 is arranged tilted in the rotation direction.

That is, in this case, as described above, the first tracks (SI1, SI2) of the disc 110 oppose, in a inclined manner, the first light receiving arrays (PI1, PI2) that are arranged at mutually offset positions in the width direction (R). As a result, a phase shift from each other occurs in the incremental signals (I1, I2).

For example, when the first tracks (SI1, SI2) oppose the first light receiving arrays (PI1, PI2) in a inclined manner as illustrated by an imaginary line (SL1) in FIG. 5, the phase of the incremental signal (I1) is more advanced than the case where a phase shift is not occurring. Further, when the first tracks (SI1, SI2) oppose the first light receiving arrays (PI1, PI2) in a inclined manner as illustrated by an imaginary line (SL2) in FIG. 5, the phase of the incremental signal (I1) is more retarded than the case where a phase shift is not occurring. When the measurement direction (C) is opposite to an arrow direction illustrated in FIG. 5, the above-described phase shifts are opposite.

Therefore, as described above, in the case where eccentricity exists between the disc 110 and the shaft (SH) or the optical module 120 is arranged tilted in the rotation direction, when the phase of the first data (D1) is in the first phase range and the absolute signal (A1) is selected as the absolute position identification absolute signal, there is a risk that the absolute position is identified using an absolute signal in a region such as a changing point of a detection pattern where the amplitude of the detection pattern is unstable. On the other hand, when the phase of the first data (D1) is in the second phase range and the absolute signal (A1) is selected as the absolute position identification absolute signal, there is a risk that the absolute position is identified using an absolute signal in a region such as a changing point of a detection pattern where the amplitude of the detection pattern is unstable. Therefore, there is a risk that the detection accuracy decreases.

In the present embodiment, as described above, the controller 130 selects one of the absolute signals (A1, A2) based on the incremental signals (I1, I2). As a result, it is possible to select an absolute signal while taking into consideration the above-described phase shift of the incremental signals (I1, I2). In this case, the controller 130, based on the incremental signals (I1, I2), generates a selection reference signal that is used for selecting one of the absolute signals (A1, A2), and, based on the selection reference signal, selects one of the absolute signals (A1, A2). A method for selecting an absolute signal by the controller 130 is not limited to a method in which a selection reference signal is used, and is not particularly limited as long as it is a method in which the incremental signals (I1, I2) are used. However, for the convenience of the description, in the following, a case is described where the method for selecting an absolute signal by the controller 130 is a method in which a selection reference signal is used.

That is, as illustrated in FIG. 6, the controller 130 includes a signal generation part 133 and a signal selection part 134.

The signal generation part 133 generates a selection reference signal based on the incremental signals (I1, I2). As a result, a selection reference signal can be generated so that a phase shift thereof with respect to an absolute signal is reduced. In this case, the signal generation part 133 generates an average signal resulting from averaging the incremental signals (I1, I2), and, based on the average signal and the incremental signals, causes the phase of the selection reference signal to match the phase of the average signal. Processing content of the signal generation part 133 is not limited to content of averaging the incremental signals (I1, I2) and generating the selection reference signal based on the average signal and the incremental signals. The processing content of the signal generation part 133 is not particularly limited as long as it is content in which the incremental signals (I1, I2) are used to generate a selection reference signal, such as that in which the incremental signals (I1, I2) are added and a selection reference signal is generated based on a signal resulting from the addition and the incremental signals. However, for the convenience of the description, in the following, a case is described where the signal generation part 133 averages the incremental signals (I1, I2) and generates a selection reference signal based on the average signal and the incremental signals.

That is, the signal generation part 133 includes an average signal generation part 331 and a first phase matching part 332.

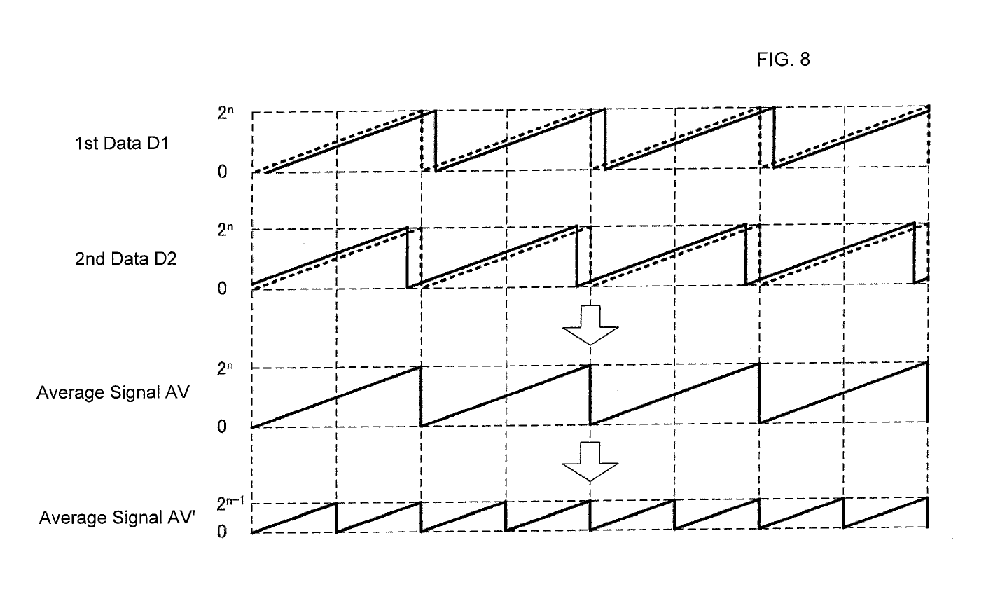

The average signal generation part 331 generate the average signal based on the incremental signals (I1, I2) and outputs the average signal to the first phase matching part 332. As a result, it is possible that the above-described phase shift of the incremental signals (I1, I2) is canceled out and a phase shift of the average signal with respect to the absolute signals (A1, A2) is reduced. More specifically, the average signal generation part 331 acquires the first data (D1) from the first position identification part 131 and acquires the second data (D2) from the second position identification part 132. Then, the average signal generation part 331, based on the acquired data (D1, D2), generates an average signal (AV) (see FIG. 8 to be described later) resulting from averaging the data (D1, D2). That is, the average signal (AV) is a periodic signal having the same resolution (n-bit resolution) as the data (D1, D2) and is represented by the following Formula 2.

AV=(D1+D2)/2 Formula 2

Thereafter, the average signal generation part 331 performs a frequency division process that reduces the resolution of the generated average signal (AV) by one bit, and outputs an average signal (AV′) (see FIG. 8 to be described later) after the frequency division process to the first phase matching part 332. That is, the average signal (AV′) is a periodic signal having a resolution ((n−1)-bit resolution) that is one bit lower than the resolution of the average signal (AV) and is represented by the following Formula 3.

AV′=mod(AV, 2ⁿ⁻¹) Formula 3

Here, mod(AV, 2ⁿ⁻¹) is a function that means a remainder when AV is divided by 2ⁿ⁻¹.

The average signal that the average signal generation part 331 outputs to the first phase matching part 332 is not limited to the average signal (AV′) after the frequency division process, but may also be the average signal (AV). However, for the convenience of the description, in the following, a case is described where the average signal that the average signal generation part 331 outputs to the first phase matching part 332 is the average signal (AV′) after the frequency division process.

FIG. 8 illustrates an example of the average signals (AV, AV′).

In FIG. 8, a saw-tooth waveform (solid line) of an uppermost row is a waveform of the first data (D1) of which the phase is more advanced than that in the case where a phase shift is not occurring (dashed line). A saw-tooth waveform (solid line) of a second row from top is a waveform of the second data (D2) of which the phase is more retarded than that in the case where a phase shift is not occurring (dashed line). In FIG. 8, the waveforms of the data (D1, D2) are illustrated in saw-tooth shapes. However, in practice, a sloped portion of the waveforms changes stepwise.

A saw-tooth waveform of a third row from top is a waveform of the average signal (AV) resulting from averaging the first data (D1) that illustrates the waveform in the uppermost row and the second data (D2) that illustrates the waveform in the second row from top. A saw-tooth waveform of a lowest row is a waveform of the average signal (AV′) after subjecting the average signal (AV) that illustrates the waveform in the third row from top to the frequency division process. In FIG. 8, similar to the waveforms of the data (D1, D2), the waveforms of the average signals (AV, AV′) are illustrated in saw-tooth shapes. However, in practice, a sloped portion of the waveforms changes stepwise.

As illustrated in FIG. 6, the first phase matching part 332, based on the average signal (AV′) and the incremental signals, causes the phase of the selection reference signal to match the phase of the average signal (AV′). As a result, a selection reference signal can be generated so that a phase shift thereof with respect to an absolute signal is reduced. In this case, the first phase matching part 332, based on the average signal (AV′) and one of the data (D1, D2), causes the phase of the selection reference signal to match the phase of the average signal (AV′). The data that the first phase matching part 332 uses may be any one of the data (D1, D2). However, in this example, a case is described where the data that the first phase matching part 332 uses is the second data (D2). That is, the first phase matching part 332 acquires the average signal (AV′) from the average signal generation part 331 and acquires the second data (D2) from the second position identification part 132. Then, the first phase matching part 332, based on the acquired average signal (AV′) and the second data (D2), performs a subtraction process that calculates a difference between the second data (D2) and the average signal (AV′) and generates a selection reference signal (SS). That is, the selection reference signal (SS) is a pulse waveform that is synchronized with phase variation of the average signal (AV′), and is represented by the following Formula 4.

SS=mod{(D2+2ⁿ)−AV′, 2ⁿ} Formula 4

Here, mod{(D2+2ⁿ)−AV′, 2ⁿ} is a function that means a remainder when (D2+2ⁿ)−AV′ is divided by 2ⁿ.

Thereafter, the first phase matching part 332 performs a process in which an amplitude of the generated selection reference signal (SS) is set to “1” and outputs a selection reference signal (SS′) after the process to the signal selection part 134. That is, the selection reference signal (SS′) is a pulse waveform that is synchronized with phase variation of the average signal (AV′) and has the amplitude that is set to be 1, and is represented by the following Formula 5.

SS′=ROUND{(SS+2ⁿ⁻²)/2ⁿ⁻¹, 0} Formula 5

Here, ROUND{(SS+2ⁿ⁻²)/2ⁿ⁻¹, 0} is a function that means to round (SS+2ⁿ⁻²)/2ⁿ⁻¹ to a nearest integer.

The selection reference signal that the first phase matching part 332 outputs to the signal selection part 134 is not limited to the selection reference signal (SS′) after the process, but may also be the selection reference signal (SS). However, for the convenience of the description, in the following, a case is described where the selection reference signal that the first phase matching part 332 outputs to the signal selection part 134 is the selection reference signal (SS′) after the process.

Further, the processes and the like that are performed by the average signal generation part 331 and the first phase matching part 332 of the signal generation part 133 are not limited to the examples of division of the processes. For example, these processes may be performed by one processing part or may be performed by three or more processing parts that are further subdivided.

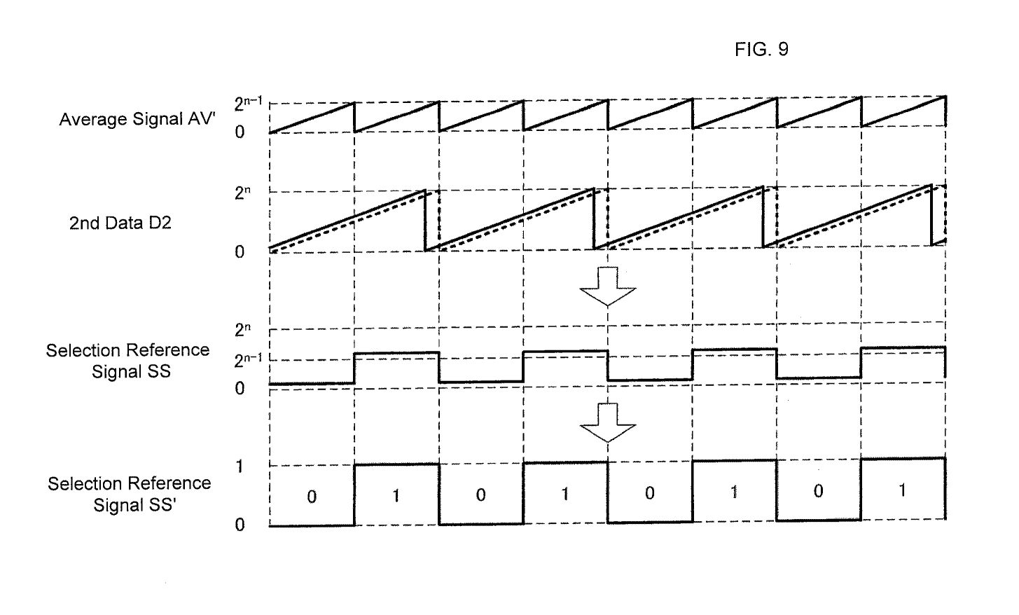

FIG. 9 illustrates an example of the selection reference signals (SS, SS′).

In FIG. 9, a saw-tooth waveform of an uppermost row is a waveform that is the same as the waveform of the average signal (AV′) illustrated in the lowest row in FIG. 8. A saw-tooth waveform of a second row from top is a waveform that is the same as the waveform of the second data (D2) that is illustrated in the second row from top in FIG. 8.

A pulse waveform of a third row from top is a waveform of the selection reference signal (SS) after performing the subtraction process based on the second data (D2) that illustrates the waveform in the second row from top and the average signal (AV′) that illustrates the waveform in the uppermost row. A pulse waveform of a lowest row is a waveform of the selection reference signal (SS′) after performing the process in which the amplitude of the selection reference signal (SS) that illustrates the waveform in the third row from top is set to “1.”

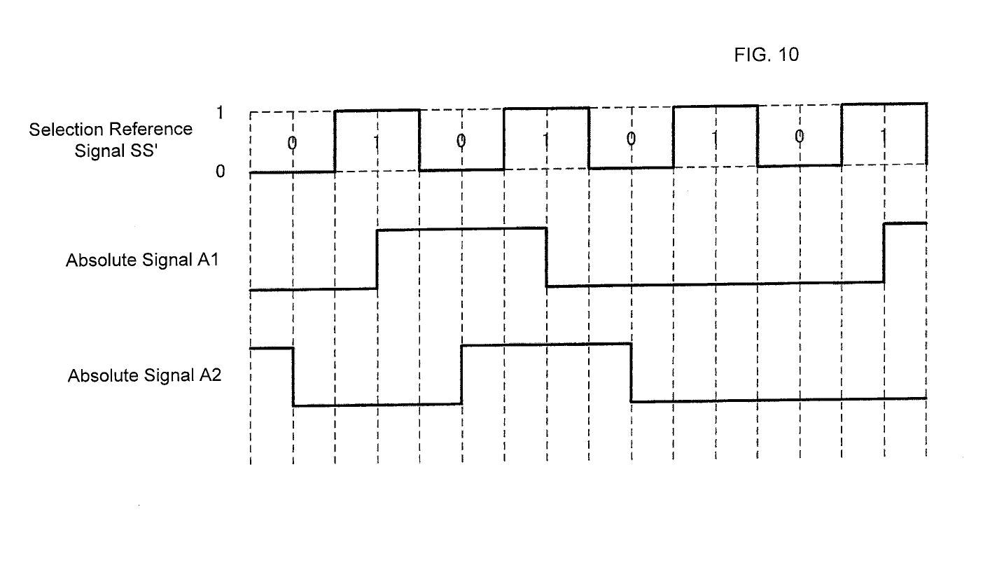

FIG. 10 illustrates an example of a relation between the selection reference signal (SS′) and the absolute signals (A1, A2).

In FIG. 10, a saw-tooth waveform of an upper row is a waveform that is the same as the waveform of the selection reference signal (SS′) that is illustrated in the lowest row in FIG. 9. A pulse waveform of a middle row is a waveform that is the same as the waveform of the absolute signal (A1) that is illustrated in the middle row in FIG. 7. A pulse waveform of a lower row is a waveform that is the same as the waveform of the absolute signal (A2) that is illustrated in the lower row in FIG. 7.

As illustrated in FIG. 10, the waveform of the absolute signal (A1) has an On-Off transition when an amplitude value of the selection reference signal (SS′) is “1,” and the waveform of the absolute signal (A2) has an On-Off transition when the amplitude value of the selection reference signal (SS′) is “0.” A correspondence relationship between the amplitude values “0” and “1” of the selection reference signal (SS′) and the On-Off transitions of the absolute signals (A1, A2) may be reversed.

That is, when the amplitude value of the selection reference signal (SS′) is “0,” the amplitude of the absolute signal (A1) is more stable than that of the absolute signal (A2). On the other hand, when the amplitude value of the selection reference signal (SS′) is “1,” the amplitude of the absolute signal (A2) is more stable than that of the absolute signal (A1). Here, the amplitude values “0” and “1” of the selection reference signal (SS′) are for a same phase range (180 degrees in electrical angle), but may also be for different phase ranges, and further the phase ranges may be other than 180 degrees in electrical angle.

Therefore, when the amplitude value of the selection reference signal (SS′) is “0,” the absolute signal (A1) can be selected as the absolute position identification absolute signal. On the other hand, when the amplitude value of the selection reference signal (SS′) is “1,” the absolute signal (A2) can be selected as the absolute position identification absolute signal. As a result, the absolute position can be identified using an absolute signal that is not in a region such as a changing point of a detection pattern where the amplitude of the detection pattern is unstable. Therefore, the detection accuracy can be improved.

As illustrated in FIG. 6, the signal selection part 134 acquires the selection reference signal (SS′) from the first phase matching part 332 and acquires the absolute signals (A1, A2) from the second light receiving arrays (PA1, PA2). Then, the signal selection part 134, based on the acquired selection reference signal (SS′), selects one of the acquired absolute signals (A1, A2). That is, the signal selection part 134 selects the absolute signal (A1) when the amplitude value of the selection reference signal (SS′) is “0,” and selects the absolute signal (A2) when the amplitude value of the selection reference signal (SS′) is “1.” As a result, an absolute signal that is not in a region such as a changing point of a detection pattern where the amplitude of the detection pattern is unstable can be selected. Then, the signal selection part 134 outputs the above-selected one of the absolute signals to the third position identification part 135. As a result, the third position identification part 135, based on the one of the absolute signals that is acquired from the signal selection part 134, identifies the first absolute position as described above, and outputs the third data to the position data generation part 136.

The processes and the like that are performed by the first position identification part 131, the second position identification part 132, the signal generation part 133, the signal selection part 134, the third position identification part 135 and the position data generation part 136 of the controller 130 are not limited to the examples of division of the processes. For example, these processes may be performed by one processing part or may be performed by seven or more processing parts that are further subdivided.

Example of Position Data Generation Method of Encoder

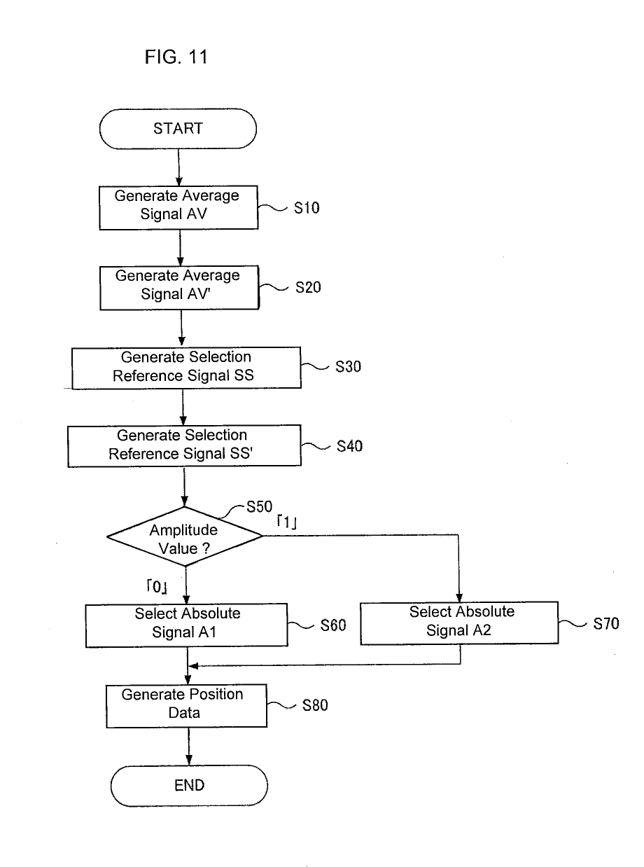

With reference to FIG. 11, an example is described of control procedures that the controller 130 executes related to a position data generation method of the encoder 100 according to the present embodiment.

As illustrated in FIG. 11, at step (S10), the controller 130, via the average signal generation part 331, generates the average signal (AV) by executing the process represented by the above (Formula 2) based on the first data (D1) generated by the first position identification part 131 and the second data (D2) generated by the second position identification part 132.

Thereafter, at step (S20), the controller 130, via the average signal generation part 331, generates the average signal (AV′) by executing the process represented by the above Formula 3 based on the average signal (AV) generated at the above step (S10).

Then, at step (S30), the controller 130, via the first phase matching part 332, generates the selection reference signal (SS) by executing the process represented by the above Formula 4 based on the average signal (AV′) generated at the above step (S20) and the second data (D2) generated by the second position identification part 132.

Thereafter, at step (S40), the controller 130, via the first phase matching part 332, generates the selection reference signal (SS′) by executing the process represented by the above (Formula 5) based on the selection reference signal (SS) generated at the above step (S30).

Then, at step (S50), the controller 130 judges the amplitude value of the selection reference signal (SS′) generated at the above step (S40). In this case, when the amplitude value of the selection reference signal (SS′) is “0,” the processing proceeds to step (S60), and the controller 130, via the signal selection part 134, selects the absolute signal (A1). On the other hand, when the amplitude value of the selection reference signal (SS′) is “1,” the processing proceeds to step (S70), and the controller 130, via the signal selection part 134, selects the absolute signal (A2). After step (S60) or step (S70) is executed, the processing proceeds to step (S80).

At step (S80), the controller 130, via the position data generation part 136, generates the position data as described above based on the third data and the second data (D2), the third data being generated by the third position identification part 135 based on the one of the absolute signals that is selected at the above step (S60) or step (S70), and the second data (D2) being generated by the second position identification part 132. As a result, the process represented by the flowchart illustrated in FIG. 11 is completed.

In FIG. 11, steps (S10, S20, S30, S40) correspond to an example of a signal generation step. Among steps (S10, S20, S30, S40), steps (S10, S20) correspond to an example of an average signal generation step and steps (S30, S40) correspond to an example of a first phase matching step. Further, steps (S60, S70) correspond to an example of a signal selection step. Further, step (S80) corresponds to an example of a position data generation step.

Examples of Effects of Present Embodiment

As described above, in the present embodiment, the position data generation part 136 generates the position data based on one or more of the incremental signals (I1, I2) and one of the absolute signals (A1, A2). The absolute signal that is used in this case is one of the absolute signals (A1, A2) that is selected based on the incremental signals (I1, I2).

Here, the first light receiving arrays (PI1, PI2) are arranged at mutually offset positions in the width direction (R). Therefore, in the case where eccentricity exists between the disc 110 and the shaft (SH) or the optical module 120 is arranged tilted in the rotation direction, the first tracks (SI1, SI2) oppose, in a inclined manner, the first light receiving arrays (PI1, PI2). Therefore, a phase shift from each other occurs in the incremental signals (I1, I2).

In the present embodiment, one of the absolute signals (A1, A2) is selected based on the incremental signals (I1, I2). Therefore, it is possible to select an absolute signal while taking into consideration the phase shift. Therefore, even when the eccentricity exists between the disc 110 and the shaft (SH) or the optical module 120 is arranged tilted in the rotation direction as described above, detection error of the absolute position can be reduced and reliability of the position data can be improved.

Further, in the present embodiment, in particular, the following effects can be obtained. That is, the absolute signal that is used when the position data generation part 136 generates the position data is one of the absolute signals that is selected based on the selection reference signal (SS′) generated by the signal generation part 133.

Here, when one of the incremental signals (I1, I2) is used to select one of the absolute signals (A1, A2) as the selection reference signal (SS′), from a viewpoint of ensuring reliability of the absolute signals (A1, A2), it is preferable that a phase shift between the selection reference signal (SS′) and the absolute signals (A1, A2) be as small as possible. However, in the case where eccentricity exists between the disc 110 and the shaft (SH) or the optical module 120 is arranged tilted in the rotation direction as described above, there is a possibility that a phase shift from each other occurs between the selection reference signal (SS′) and the absolute signals (A1, A2).

Further, in the case where eccentricity exists between the disc 110 and the shaft (SH) or the optical module 120 is arranged tilted in the rotation direction as described above, a phase shift from each other occurs in the incremental signals (I1, I2) that respectively output from the first light receiving arrays (PI1, PI2) as described above.

In the present embodiment, the selection reference signal (SS′) is generated based on the incremental signals (I1, I2). Therefore, the selection reference signal (SS′) can be generated so that a phase shift thereof with respect to the absolute signals (A1, A2) is reduced. Therefore, even when the eccentricity exists between the disc 110 and the shaft (SH) or the optical module 120 is arranged tilted in the rotation direction as described above, detection error of the absolute position can be reduced and reliability of the position data can be improved.

Further, in the present embodiment, in particular, the second light receiving arrays (PA1, PA2) are arranged sandwiching the light source 121 therebetween in the width direction (R). In such an arrangement, phase shifts of the incremental signals (I1, I2) of the first light receiving arrays (PI1, PI2), which are arranged at positions between the second light receiving arrays (PA1, PA2) in the width direction (R), with respect to the absolute signals (A1, A2) are reduced.

In the present embodiment, the signal generation part 133 generates the selection reference signal (SS′) based on the incremental signals (I1, I2) of the first light receiving arrays (PI1, PI2) that are arranged on the inner side of the second light receiving arrays (PA1, PA2) in the width direction (R), in other words, based on the incremental signals (I1, I2) that have relatively small phase shifts with respect to the absolute signals (A1, A2). As a result, the selection reference signal (SS′) can be generated so that a phase shift thereof with respect to the absolute signals (A1, A2) is reduced.

Further, in the present embodiment, in particular, the first light receiving arrays (PI1, PI2) are arranged sandwiching the light source 121 therebetween in the width direction (R). In such an arrangement, in the case where eccentricity exists between the disc 110 and the shaft (SH) or the optical module 120 is arranged tilted in the rotation direction as described above, the phase of the incremental signal of one of the first light receiving arrays is advanced and the phase of the incremental signal of the other one of the first light receiving arrays is retarded. Therefore, by generating the average signal (AV′) resulting from averaging the incremental signals (I1, I2), the phase shifts of the incremental signals (I1, I2) can be canceled out and the phase shift of the average signal (AV′) with respect to the absolute signals (A1, A2) can be reduced. Then, the first phase matching part 332 causes the phase of the selection reference signal (SS′) to match the phase of the average signal (AV′). As a result, the selection reference signal (SS′) can be generated so that a phase shift thereof with respect to the absolute signals (A1, A2) is reduced.

Further, in the present embodiment, in particular, the first light receiving arrays (PI1, PI2) and the second light receiving arrays (PA1, PA2) are arranged to be symmetrical in the width direction (R) around the light source 121. In such an arrangement, for a light receiving signal of a light receiving array arranged at the same position as the light source 121 in the width direction (R), a phase shift with respect to the absolute signals (A1, A2) is the smallest. In this case, the average signal (AV′) resulting from averaging the incremental signals (I1, I2) has a phase that is substantially the same as that of the light receiving signal of the light receiving array that is arranged at the same position as the light source 121 in the width direction (R). Therefore, the phase shift of the average signal (AV′) with respect to the absolute signals (A1, A2) can be reduced as much as possible. Then, the first phase matching part 332 causes the phase of the selection reference signal (SS′) to match the phase of the average signal (AV′). As a result, the selection reference signal (SS′) can be generated so that a phase shift thereof with respect to the absolute signals (A1, A2) is reduced as much as possible.

Further, in the present embodiment, in particular, the first tracks (SI1, SI2) and the second tracks (SA1, SA2) each reflect light emitted by the light source 121. The first light receiving arrays (PI1, PI2) and the second light receiving arrays (PA1, PA2) respectively receive light reflected by the first tracks (SI1, SI2) or the second tracks (SA1, SA2). In this way, by structuring the encoder 100 as a reflective encoder, the first light receiving arrays (PI1, PI2) and the second light receiving arrays (PA1, PA2) can be arranged close to the light source 121. Therefore, encoder 100 can be miniaturized.

### Second Embodiment

A second embodiment is described. In the second embodiment, parts that are different from the first embodiment are mainly described. Further, structural elements having substantially the same functions as in the first embodiment are in principle denoted using the same reference numerals, and redundant description thereof is omitted as appropriate.

Tracks

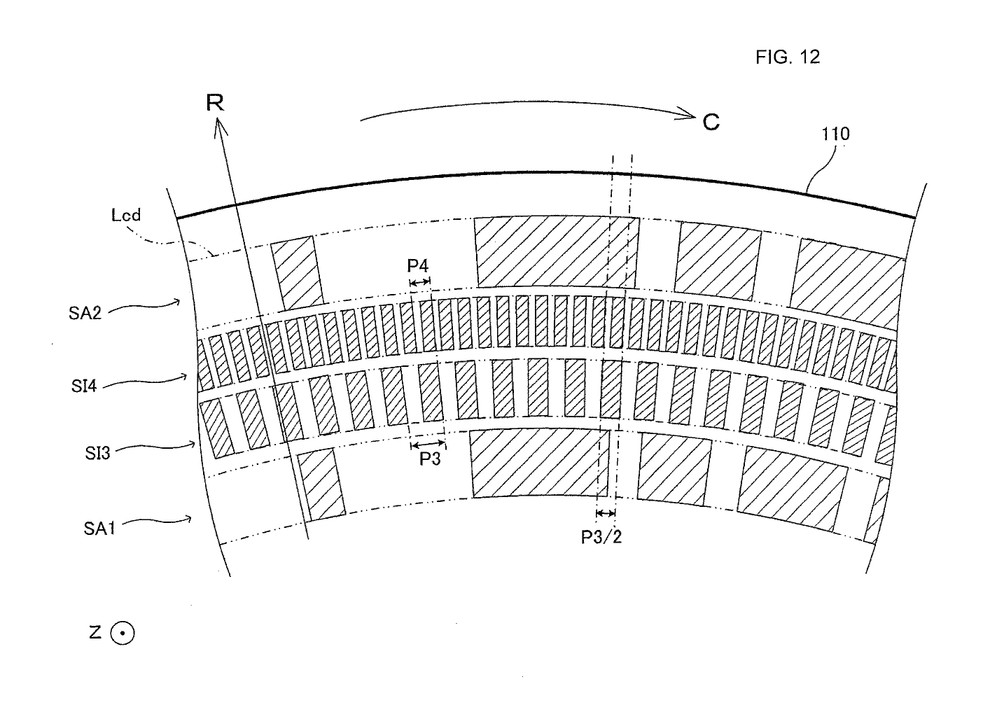

As illustrated in FIG. 12, in the present embodiment, on the upper surface of the disc 110, as the first tracks, two first tracks (SI3, SI4) are provided; and as the one or more second tracks, the above-described second tracks (SA1, SA2) are provided. The tracks including the first tracks and the second tracks are concentrically arranged in an order of the second track (SA1), the first track (SI3), the first track (SI4) and the second track (SA2) from the inner side to the outer side in the width direction (R).

The reflection slits of the second tracks (SA1, SA2) are arranged similar to the first embodiment.

On the other hand, the reflection slits of each of the first tracks (SI3, SI4) are arranged over the entire circumference of the disc 110 having an incremental pattern along the measurement direction (C). A pitch of the reflection slits of the first track (SI3) is P3, and a pitch of the reflection slits of the first track (SI4) is P4.

In the present embodiment, the pitch (P3) is set to be longer than the pitch (P4). In this example, the pitches are set so that P3=2×P4. Therefore, the number of the reflection slits of the first track (SI4) is twice the number of the reflection slits of the first track (SI3). A relation between the pitches is not necessarily required to be that one pitch is twice the other. Various kinds of relations between the pitches are possible such as that one pitch is set be three times, four times or five times of the other pitch, and the like.

In the present embodiment, a minimum length of the reflection slits of the second tracks (SA1, SA2) in the measurement direction (C) coincides with the pitch (P3). As a result, a resolution of a light receiving signal of the second light receiving arrays corresponding to the second tracks (SA1, SA2) coincides with the number of the reflection slits of the first track (SI3). The minimum length is not necessarily required to coincide with the pitch (P3). It is desirable that the number of the reflection slits of the first track (SI3) be formed the same as or more than the resolution of the light receiving signal of the second light receiving arrays corresponding to the second tracks (SA1, SA2).

Further, the lengths of the reflection slits of the second tracks (SA1, SA2) in the measurement direction (C) coincide with integer multiples of the pitch (P3). The lengths are not necessarily required to be integer multiples of the pitch (P3).

Further, a position of an end corresponding to the measurement direction (C) of each of the reflection slits of the second track (SA1) is offset from a position of an end corresponding to the measurement direction (C) of a reflection slit of the first track (SI3) to one side of the measurement direction (C). The offset amount corresponds to one quarter of the pitch (P3)(=(P3)/4). Similarly, a position of an end corresponding to the measurement direction (C) of each of the reflection slits of the second track (SA2) is offset from a position of an end corresponding to the measurement direction (C) of a reflection slit of the first track (SI3) to the other side of the measurement direction (C). The offset amount corresponds to one quarter of the pitch (P3)(=(P3)/4). The offset amount is not necessarily required to be one quarter of the pitch (P3), but may take various values. Further, the end corresponding to the measurement direction (C) of the each of the reflection slits of the second tracks (SA1, SA2) and the end corresponding to the measurement direction (C) of the reflection slit of the first track (SI3) are not necessarily required to be offset in the measurement direction (C), but a case where the two are not offset in the measurement direction (C) is also possible.

Light Receiving Array

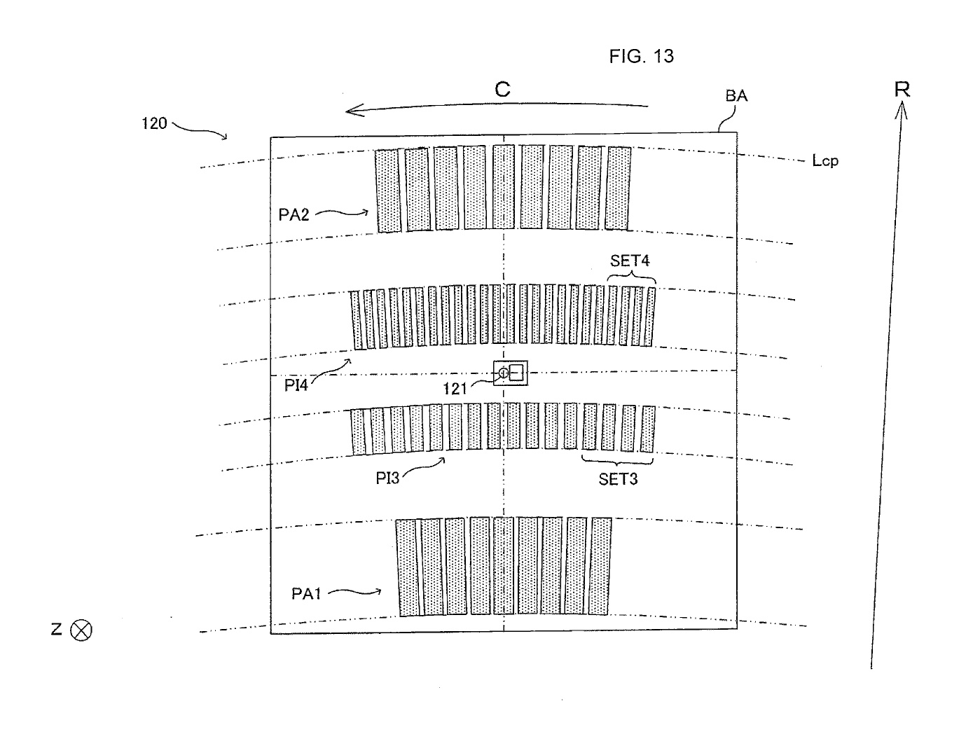

As illustrated in FIG. 13, in the present embodiment, on the lower surface of the substrate (BA) of the optical module 120, as the first light receiving arrays, two first light receiving arrays (PI3, PI4) are provided; and as the two second light receiving arrays, the above-described second light receiving arrays (PA1, PA2) are provided. The light receiving arrays including the first light receiving arrays and the second light receiving arrays are concentrically arranged in an order of the second light receiving array (PA1), the first light receiving array (PI3), the first light receiving array (PI4) and the second light receiving array (PA2) from the inner side to the outer side in the width direction (R).

Further, the light receiving arrays (PA1, PI3, PI4, PA2) are arranged in correspondence to the tracks (SA1, SI3, SI4, SA2). That is, the first light receiving array (PI3) is arranged in correspondence to the first track (SI3). The light receiving elements of the first light receiving array (PI3) receive light reflected by the reflection slits of the first track (SI3) to output a light receiving signal. Further, the first light receiving array (PI4) is arranged in correspondence to the first track (SI4). The light receiving elements of the first light receiving array (PI4) receive light reflected by the reflection slits of the first track (SI4) to output a light receiving signal. The second light receiving array (PA1), similar to the first embodiment, is arranged in correspondence to the second track (SA1). The second light receiving array (PA2), similar to the first embodiment, is arranged in correspondence to the second track (SA2).

The second light receiving arrays (PA1, PA2) are arranged similar to the first embodiment. That is, the second light receiving arrays (PA1, PA2) are arranged to be symmetrical in the width direction (R) around the light source 121. The second light receiving array (PA1) is arranged on the inner side in the width direction (R), and the second light receiving array (PA2) is arranged on the outer side in the width direction (R). Therefore, similar to the first embodiment, the distance between the second light receiving array (PA1) and the light source 121 and the distance between the second light receiving array (PA2) and the light source 121 are equal.

On the other hand, as described above, the first light receiving arrays (PI3, PI4) are arranged at mutually offset positions in the width direction (R). In this case, the first light receiving arrays (PI3, PI4) are arranged on an inner side of the second light receiving arrays (PA1, PA2) in the width direction (R). In this example, the first light receiving array (PI3) is arranged on an inner side in the width direction (R), and the first light receiving array (PI4) is arranged on an outer side in the width direction (R). Specifically, the first light receiving arrays (PI3, PI4) are arranged sandwiching the light source 121 therebetween on the inner side of the second light receiving arrays (PA1, PA2) in the width direction (R). That is, the first light receiving array (PI3) is arranged between the light receiving array (PA1) and the light source 121 in the width direction (R), and the first light receiving array (PI4) is arranged between the light source 121 and the light receiving array (PA2) in the width direction (R). In this case, the first light receiving arrays (PI3, PI4) are arranged to be symmetrical in the width direction (R) about the light source 121. The first light receiving arrays (PI3, PI4) may also be arranged to be asymmetric in the width direction (R) about the light source 121. However, for the convenience of the description, in the following, the case is described where the first light receiving arrays (PI3, PI4) are arranged to be symmetrical in the width direction (R) about the light source 121. Therefore, a distance between the first light receiving array (PI3) and the light source 121 and a distance between the first light receiving array (PI4) and the light source 121 are equal. That is, the first light receiving arrays (PI3, PI4) (except curved shapes centered on the above-described measurement center (Os)) are basically formed in line-symmetric shapes with lines passing through the light source 121 along the width direction (R) and along the measurement direction (C) as axes of symmetry.

Further, in the first light receiving arrays (PI3, PI4), by receiving light reflected by the corresponding first tracks (SI3, SI4), a light receiving signal is output. That is, the light receiving signal from the first light receiving arrays (PI3, PI4) corresponds to an example of a first light receiving signal.

The first light receiving array (PI3) is structured similar to the above-described first light receiving arrays (PI1, PI2). That is, in one pitch of the track (SI3) (one pitch in a projected image, that is, ε×P3), a set (indicated by “SET3” in FIG. 13) of a total of four light receiving elements is arranged, and multiple sets each including four light receiving elements are further arranged along the measurement direction (C). Therefore, from a large number of light receiving elements of the first light receiving array (PI3), four light receiving signals of which the phases are shifted by 90 degrees from each other are generated.

On the other hand, the first light receiving array (PI4) is also structured similar to the first light receiving array (PI3). That is, in one pitch of the track (SI4) (one pitch in a projected image, that is, ε×P4), a set (indicated by “SET4” in FIG. 13) of a total of four light receiving elements is arranged, and multiple sets each including four light receiving elements are further arranged along the measurement direction (C). Therefore, from a large number of light receiving elements of the first light receiving array (PI4), four light receiving signals of which the phases are shifted by 90 degrees from each other are generated.

As described above, in each of the first light receiving arrays (PI3, PI4), four light receiving signals (incremental signals) of which the phases are shifted by 90 degrees from each other are generated. For the convenience of the description, in the following, the four incremental signals of which the phases are shifted by 90 degrees from each other that are output from the first light receiving array (PI3) may also be collectively referred to as “one incremental signal.” Similarly, the four incremental signals of which the phases are shifted by 90 degrees from each other that are output from the first light receiving array (PI4) may also be collectively referred to as “one incremental signal.” The incremental signal from the first light receiving array (PI3) is also referred to as an “incremental signal (I3),” and the incremental signal from the first light receiving array (PI4) is also referred to as an “incremental signal (I4).”

Further, the incremental signal (I4) of the incremental pattern of the first track (SI4) that has a short pitch has a higher resolution as compared to the incremental signal (I3), and thus is also referred to as a “high incremental signal (I4).” Further, the incremental signal (I3) of the incremental pattern of the first track (SI3) that has a long pitch has a lower resolution as compared to the incremental signal (I4), and thus is also referred to as a “low incremental signal (I4).”

In the present embodiment, a case is described where four light receiving elements are included in one set corresponding to one pitch of the incremental pattern. However, the number of the light receiving elements included in one set is not particularly limited. For example, it is also possible that two light receiving elements are included in one set.

Controller

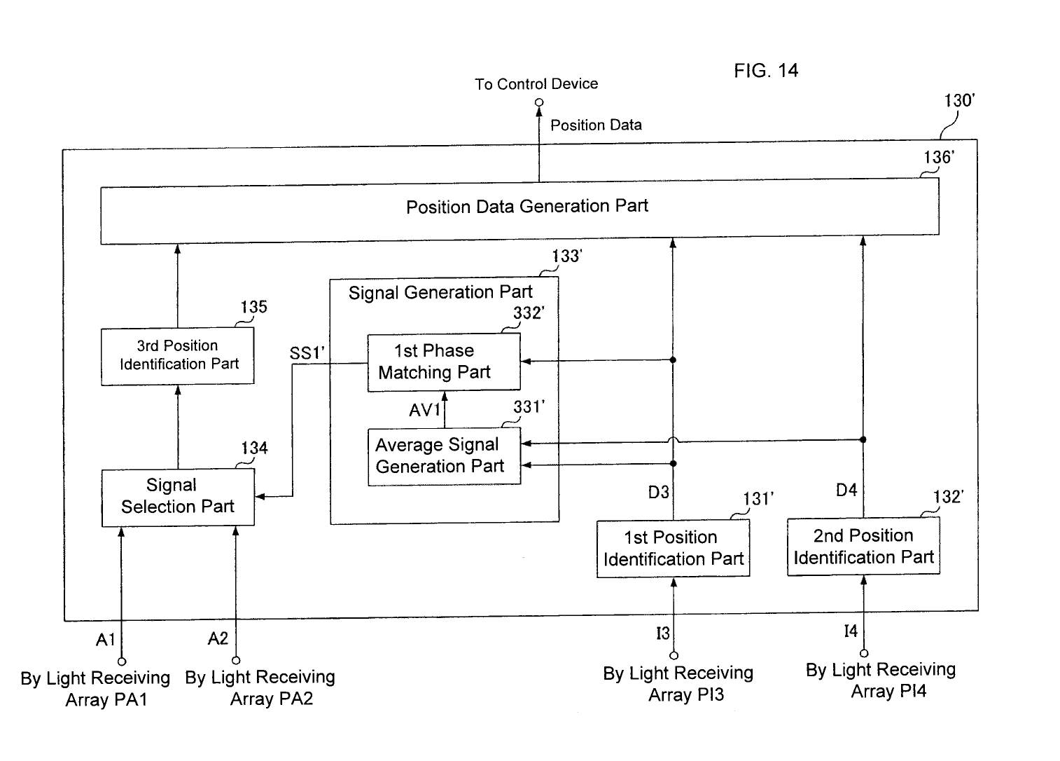

In the following, with reference to FIG. 14, with respect to an exemplary structure of the controller 130, an example of implementation using more specific functional blocks is described.

As illustrated in FIG. 14, the controller 130′ includes a first position identification part 131′, a second position identification part 132′, a signal generation part 133′, a signal selection part 134, a third position identification part 135 and a position data generation part 136′.

The second position identification part 132′ acquires from the first light receiving array (PI4) four high incremental signals (one incremental signal (I4)) of which the phases are shifted by 90 degrees from each other. Then, the second position identification part 132′ performs processing similar to the first position identification part 131, identifies a position (electrical angle) within one pitch of the first track (SI4), and generates and outputs second data representing the position.

The second data that the second position identification part 132′ outputs may be the above-generated second data itself. However, in the following, a case is described where the second data that the second position identification part 132′ outputs is second data (D4) obtained after the above-generated second data is subjected to a multiplication process. In this case, a multiplication number of the second data is not particularly limited. However, in the following, a case is described where the multiplication number of the second data is 2ⁿ. That is, the second position identification part 132′ subjects the above-generated second data to a multiplication process in which the multiplication number is 2ⁿ, and outputs the second data (D4) after the multiplication process. The second data (D4) is a periodic signal representing a position within one pitch of the first track (SI4).

The first position identification part 131′ acquires from the first light receiving array (PI3) four low incremental signals (one incremental signal (I3)) of which the phases are shifted by 90 degrees from each other. Then, the first position identification part 131′ performs processing similar to the first position identification part 131, identifies a position (electrical angle) within one pitch of the first track (SI3), and generates and outputs first data representing the position.

The first data that the first position identification part 131′ outputs may be the above-generated first data itself However, in the following, a case is described where the first data that the first position identification part 131′ outputs is first data (D3) obtained after the above-generated first data is subjected to a multiplication process. In this case, a multiplication number of the first data is not particularly limited. However, in the following, a case is described where the multiplication number of the first data is 2ⁿ⁺¹, and the resolution of the first data after the multiplication process and the resolution of the second data after the multiplication process are the same. That is, the first position identification part 131′ subjects the above-generated first data to a multiplication process in which the multiplication number is 2ⁿ⁺¹, and outputs the first data (D3) after the multiplication process. The first data (D3) is a periodic signal representing a position within one pitch of the first track (SI3).

Here, a case is described where eccentricity exists between the disc 110 and the shaft (SH), or the optical module 120 is arranged tilted in the rotation direction, or both the eccentricity exists between the disc 110 and the shaft (SH) and the optical module 120 is arranged tilted in the rotation direction. In this case, as described above, the first tracks (SI3, SI4) of the disc 110 oppose, in a inclined manner, the first light receiving arrays (PI3, PI4) that are arranged at mutually offset positions in the width direction (R). As a result, a phase shift from each other occurs in the incremental signals (I3, I4).

In the present embodiment, the controller 130′ selects one of the absolute signals (A1, A2) based on the incremental signals (I3, I4). As a result, it is possible to select an absolute signal while taking into consideration the above-described phase shift of the incremental signals (I3, I4). In this case, the controller 130′, based on the incremental signals (I3, I4), generates the above-described selection reference signal and, based on the selection reference signal, selects one of the absolute signals (A1, A2). A method for selecting an absolute signal by the controller 130′ is not limited to a method in which a selection reference signal is used, and is not particularly limited as long as it is a method in which the incremental signals (I3, I4) are used. However, for the convenience of the description, in the following, a case is described where the method for selecting an absolute signal by the controller 130′ is a method in which a selection reference signal is used.

The signal generation part 133′ generates a selection reference signal based on the incremental signals (I3, I4). As a result, a selection reference signal can be generated so that a phase shift thereof with respect to an absolute signal is reduced. In this case, the signal generation part 133′ generates an average signal resulting from averaging the incremental signals (I3, I4), and, based on the average signal and the incremental signals, causes the phase of the selection reference signal to match the phase of the average signal. Processing content of the signal generation part 133′ is not limited to content of averaging the incremental signals (I3, I4) and generating the selection reference signal based on the average signal and the incremental signals. The processing content of the signal generation part 133′ is not particularly limited as long as it is content in which the incremental signals (I3, I4) are used to generate a selection reference signal, such as that in which the incremental signals (I3, I4) are added and a selection reference signal is generated based on a signal resulting from the addition and the incremental signals. However, for the convenience of the description, in the following, a case is described where the signal generation part 133′ averages the incremental signals (I3, I4) and generates a selection reference signal based on the average signal and the incremental signals.

That is, the signal generation part 133′ includes an average signal generation part 331′ and a first phase matching part 332′.

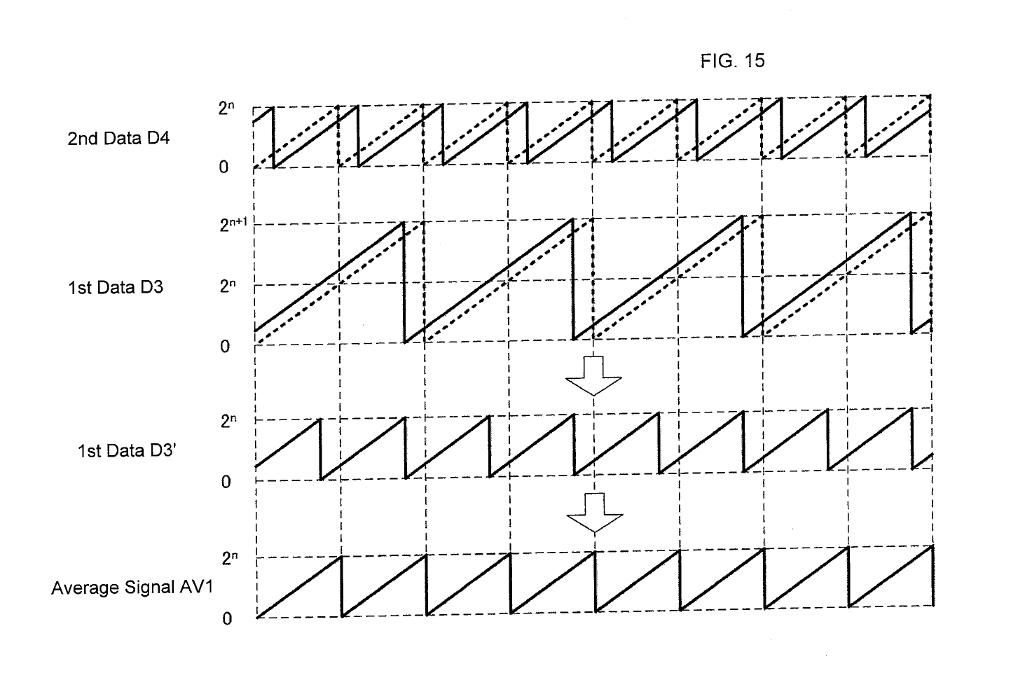

The average signal generation part 331′ generate the average signal based on the incremental signals (I3, I4) and outputs the average signal to the first phase matching part 332′. As a result, it is possible that the above-described phase shift of the incremental signals (I3, I4) is canceled out and a phase shift of the average signal with respect to the absolute signals (A1, A2) is reduced. More specifically, the average signal generation part 331′ acquires the first data (D3) from the first position identification part 131′ and acquires the second data (D4) from the second position identification part 132′. Then, the average signal generation part 331′ performs a frequency division process that reduces the resolution of the acquired first data (D3) by one bit, and uses the result of the frequency division process as first data (D3′) (see FIG. 15 to be described later).

That is, the first data (D3′) is a periodic signal having the same resolution (n-bit resolution) as the second data (D4) and is represented by the following Formula 6.

D3′=mod(D3, 2ⁿ) Formula 6

Here, mod(D3, 2ⁿ) is a function that means a remainder when D3 is divided by 2ⁿ.

Thereafter, the average signal generation part 331′, based on the acquired second data (D4) and the first data (D3′) after the frequency division process, generates average signal (AV1) resulting from averaging the data (D4, D3′) (see FIG. 15 to be described later). That is, the average signal (AV1) is a periodic signal having the same resolution (n-bit resolution) as the data (D4, D3′) and is represented by the following Formula 7.

AV1=(D4+D3′)/2 Formula 7

FIG. 15 illustrates an example of the average signal (AV1).

In FIG. 15, a saw-tooth waveform (solid line) of an uppermost row is a waveform of the second data (D4) of which the phase is more advanced than that in the case where a phase shift is not occurring (dashed line). A saw-tooth waveform (solid line) of a second row from top is a waveform of the first data (D3) of which the phase is more retarded than that in the case where a phase shift is not occurring (dashed line). A saw-tooth waveform of a third row from top is a waveform of the first data (D3′)after subjecting the first data (D3) that illustrates the waveform in the second row from top to the frequency division process. In FIG. 15, the waveforms of the data (D4, D3, D3′) are illustrated in saw-tooth shapes. However, in practice, a sloped portion of the waveforms changes stepwise.

A saw-tooth waveform of a lowest row is a waveform of the average signal (AV1) resulting from averaging the second data (D4) that illustrates the waveform in the uppermost row and the first data (D3′) that illustrates the waveform in the third row from top. In FIG. 15, similar to the waveforms of the data (D4, D3, D3′), the waveform of the average signal (AV1) is illustrated in a saw-tooth shape. However, in practice, a sloped portion of the waveform changes stepwise.

As illustrated in FIG. 14, the first phase matching part 332′, based on the average signal (AV1) and the incremental signals, causes the phase of the selection reference signal to match the phase of the average signal (AV1). As a result, a selection reference signal can be generated so that a phase shift thereof with respect to an absolute signal is reduced. In this case, the first phase matching part 332′, based on the average signal (AV1) and the first data (D3), causes the phase of the selection reference signal to match the phase of the average signal (AV1). That is, the first phase matching part 332′ acquires the average signal (AV1) from the average signal generation part 331′ and acquires the first data (D3) from the second position identification part 132′. Then, the first phase matching part 332′, based on the acquired average signal (AV1) and the first data (D3), performs a subtraction process that calculates a difference between the first data (D3) and the average signal (AV1) and generates a selection reference signal (SS1). That is, the selection reference signal (SS1) is a pulse waveform that is synchronized with phase variation of the average signal (AV1), and is represented by the following Formula 8.

SS1=mod{(D3+2ⁿ⁺¹)−AV1, 2ⁿ⁺¹} Formula 8

Here, mod{(D3+2ⁿ⁺¹)−AV1, 2ⁿ⁺¹} is a function that means a remainder when (D3+2ⁿ⁺¹)−AV1 is divided by 2ⁿ⁺¹.

Thereafter, the first phase matching part 332′ performs a process in which an amplitude of the generated selection reference signal (SS1) is set to “1” and outputs a selection reference signal (SS1′) after the process to the signal selection part 134. That is, the selection reference signal (SS1′) is a pulse waveform that is synchronized with phase variation of the average signal (AV1) and has the amplitude that is set to be 1, and is represented by the following Formula 9.

SS1′=ROUND{(SS1+2ⁿ⁻¹)/2ⁿ, 0} Formula 9

Here, ROUND{(SS1+2ⁿ⁻¹)/2ⁿ, 0} is a function that means to round (SS1+2ⁿ⁻¹)/2ⁿ to a nearest integer.

The selection reference signal that the first phase matching part 332′ outputs to the signal selection part 134 is not limited to the selection reference signal (SS1′) after the process, but may also be the selection reference signal (SS1). However, for the convenience of the description, in the following, a case is described where the selection reference signal that the first phase matching part 332′ outputs to the signal selection part 134 is the selection reference signal (SS1′) after the process.

Further, the processes and the like that are performed by the average signal generation part 331′ and the first phase matching part 332′ of the signal generation part 133′ are not limited to the examples of division of the processes. For example, these processes may be performed by one processing part or may be performed by three or more processing parts that are further subdivided.

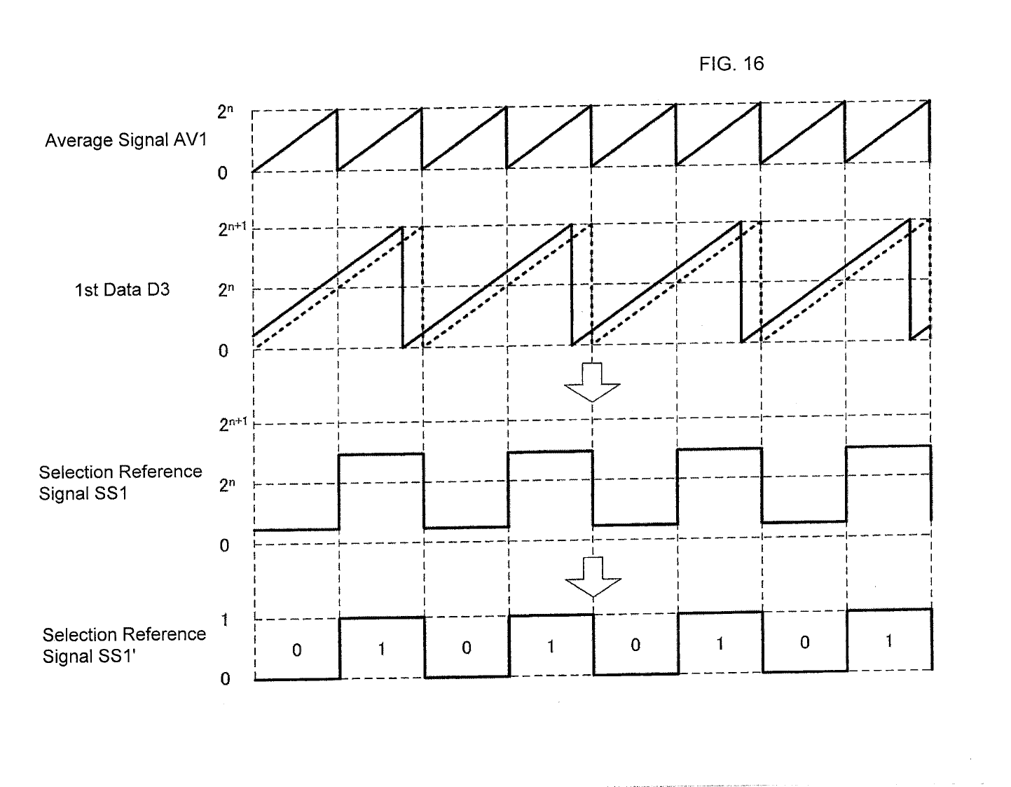

FIG. 16 illustrates an example of the selection reference signals (SS1, SS1′).

In FIG. 16, a saw-tooth waveform of an uppermost row is a waveform that is the same as the waveform of the average signal (AV1) illustrated in the lowest row in FIG. 15. A saw-tooth waveform of a second row from top is a waveform that is the same as the waveform of the first data (D3) that is illustrated in the second row from top in FIG. 15.

A pulse waveform of a third row from top is a waveform of the selection reference signal (SS1) after performing the subtraction process based on the first data (D3) that illustrates the waveform in the second row from top and the average signal (AV1) that illustrates the waveform in the uppermost row. A pulse waveform of a lowest row is a waveform of the selection reference signal (SS1′) after performing the process in which the amplitude of the selection reference signal (SS1) that illustrates the waveform in the third row from top is set to “1.”

Although not illustrated in drawings, the waveform of the absolute signal (A1) has an On-Off transition when an amplitude value of the selection reference signal (SS1′) is “1,” and the waveform of the absolute signal (A2) has an On-Off transition when the amplitude value of the selection reference signal (SS1′) is “0.” A correspondence relationship between the amplitude values “0” and “1” of the selection reference signal (SS1′) and the On-Off transitions of the absolute signals (A1, A2) may be reversed.

That is, when the amplitude value of the selection reference signal (SS1′) is “0,” the amplitude of the absolute signal (A1) is more stable than that of the absolute signal (A2). On the other hand, when the amplitude value of the selection reference signal (SS1′) is “1,” the amplitude of the absolute signal (A2) is more stable than that of the absolute signal (A1). Here, the amplitude values “0” and “1” of the selection reference signal (SS1′) are for a same phase range (180 degrees in electrical angle), but may also be for different phase ranges, and further the phase ranges may be other than 180 degrees in electrical angle.

Therefore, when the amplitude value of the selection reference signal (SS1′) is “0,” the absolute signal (A1) can be selected as the absolute position identification absolute signal. On the other hand, when the amplitude value of the selection reference signal (SS1′) is “1,” the absolute signal (A2) can be selected as the absolute position identification absolute signal. As a result, the absolute position can be identified using an absolute signal that is not in a region such as a changing point of a detection pattern where the amplitude of the detection pattern is unstable. Therefore, the detection accuracy can be improved.

As illustrated in FIG. 14, the signal selection part 134 according to the present embodiment acquires the selection reference signal (SS1′) from the first phase matching part 332′ and acquires the absolute signals (A1, A2) from the second light receiving arrays (PA1, PA2). Then, the signal selection part 134, based on the acquired selection reference signal (SS1′), selects one of the acquired absolute signals (A1, A2). That is, the signal selection part 134 selects the absolute signal (A1) when the amplitude value of the selection reference signal (SS1′) is “0,” and selects the absolute signal (A2) when the amplitude value of the selection reference signal (SS1′) is “1.” As a result, an absolute signal that is not in a region such as a changing point of a detection pattern where the amplitude of the detection pattern is unstable can be selected. Then, the signal selection part 134 outputs the above-selected one of the absolute signals to the third position identification part 135.

The third position identification part 135, based on the one of the absolute signals that is acquired from the signal selection part 134, identifies the above-described first absolute position as described above, and outputs the above-described third data to the position data generation part 136′.

The position data generation part 136′, based on one of the absolute signals (A1, A2) and one or more of the incremental signals (I3, I4), calculates the absolute position, and generates and outputs the position data that represents the absolute position to the control device (CT). That is, the position data generation part 136′ corresponds to an example of a means that generates position data.

The generation method of the position data by the position data generation part 136′ is not particularly limited as long as it is a method that uses one of the absolute signals (A1, A2) and one or more of the incremental signals (I3, I4). However, for the convenience of the description, in the following, a case is described where the position data generation part 136′, based on one of the absolute signals (A1, A2) and the incremental signals (I3, I4), generates the position data using a method as described below.

That is, the position data generation part 136′ acquires the third data from the third position identification part 135, and acquires the first data (D3) from the first position identification part 131′ and the second data (D4) from the second position identification part 132′. Then, the position data generation part 136′, by superimposing the first data (D3) (relative position) on the third data (first absolute position), calculates an absolute position that is higher in accuracy than the first absolute position. Thereafter, the position data generation part 136′, by superimposing the second data (D4) (relative position) on the above-calculated absolute position, calculates an absolute position that is further higher in resolution than the absolute position, and generates position data that represents the absolute position.

The processes and the like that are performed by the first position identification part 131′, the second position identification part 132′, the signal generation part 133′, the signal selection part 134, the third position identification part 135 and the position data generation part 136′ of the controller 130′ are not limited to the examples of division of the processes. For example, these processes may be performed by one processing part or may be performed by seven or more processing parts that are further subdivided.

Example of Position Data Generation Method of Encoder

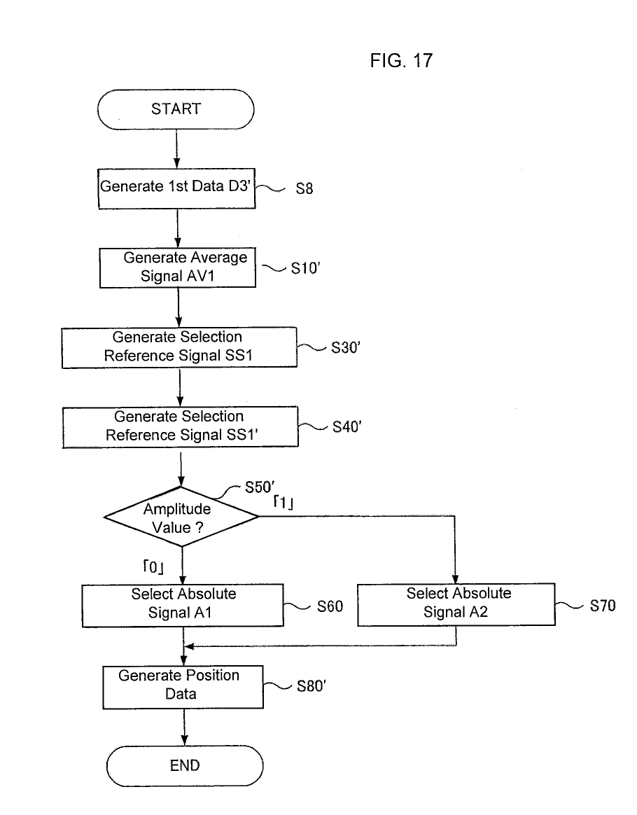

With reference to FIG. 17, an example is described of control procedures that the controller 130′ executes related to a position data generation method of the encoder 100 according to the present embodiment.

As illustrated in FIG. 17, at step (S8), the controller 130′, via the average signal generation part 331′, generates the first data (D3′) by executing the process represented by the above Formula 6 based on the first data (D3) generated by the first position identification part 131′.

Thereafter, at step (S10′), the controller 130′, via the average signal generation part 331′, generates the average signal (AV1) by executing the process represented by the above Formula 7 based on the second data (D4) generated by the second position identification part 132′ and the first data (D3′) generated at the above step (S8).

Then, at step (S30′), the controller 130′, via the first phase matching part 332′, generates the selection reference signal (SS1) by executing the process represented by the above Formula 8 based on the average signal (AV1) generated at the above step (S10′) and the second data (D4) generated by the second position identification part 132′.

Thereafter, at step (S40′), the controller 130′, via the first phase matching part 332′, generates the selection reference signal (SS1′) by executing the process represented by the above Formula 9 based on the selection reference signal (SS1) generated at the above step (S30′).

Then, at step (S50′), the controller 130′ judges the amplitude value of the selection reference signal (SS1′) generated at the above step (S40′). In this case, when the amplitude value of the selection reference signal (SS1′) is “0,” the processing proceeds to step (S60), and the controller 130′, via the signal selection part 134, selects the absolute signal (A1). On the other hand, when the amplitude value of the selection reference signal (SS1′) is “1,” the processing proceeds to step (S70), and the controller 130′, via the signal selection part 134, selects the absolute signal (A2). After step (S60) or step (S70) is executed, the processing proceeds to step (S80′).

At step (S80′), the controller 130′, via the position data generation part 136′, generates the position data as described above based on the third data, the first data (D3) and the second data (D4), the third data being generated by the third position identification part 135 based on the one of the absolute signals that is selected at the above step (S60) or step (S70), the first data (D3) being generated by the first position identification part 131′, and the second data (D4) being generated by the second position identification part 132′. As a result, the process represented by the flowchart illustrated in FIG. 17 is completed.

In FIG. 17, steps (S8, S10′, S30′, S40′) correspond to an example of a signal generation step. Among steps (S8, S10′, S30′, S40′), steps (S8, S10′) correspond to an example of an average signal generation step and steps (S30′, S40′) correspond to an example of a first phase matching step. Further, steps (S60, 70) correspond to an example of a signal selection step. Further, step (S80′) corresponds to an example of a position data generation step.

Examples of Effects of Present Embodiment

As described above, according to the present embodiment, the same effects as those of the first embodiment can be obtained. Further, in the present embodiment, the first tracks (SI3, SI4) have the incremental patterns with pitches different from each other. Therefore, the first light receiving arrays (PI3, PI4) respectively receive light reflected by the incremental patterns with pitches different from each other. That is, the encoder 100 includes the first light receiving array (PI3) of a low resolution that corresponds to the first track (SI3) of an incremental pattern with a long pitch and the first light receiving array (PI4) of a high resolution that corresponds to the first track (SI4) of an incremental pattern with a short pitch. As a result, by a so-called “building-up approach” in which an absolute position of a resolution is calculated from multiple data sets with resolutions different from each, position data representing the high resolution absolute position can be generated. Therefore, high resolution can be achieved.

### Third Embodiment

A third embodiment is described. In the third embodiment, parts that are different from the first and second embodiments are mainly described. Further, structural elements having substantially the same functions as in the first and second embodiments are in principle denoted using the same reference numerals, and redundant description thereof is omitted as appropriate.

Tracks

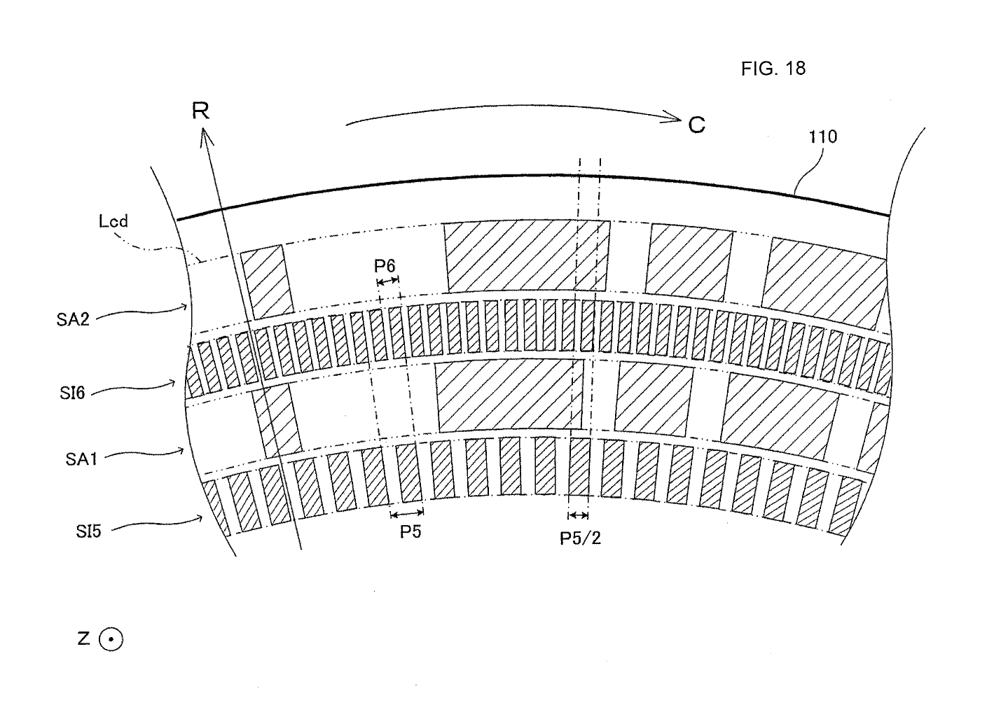

As illustrated in FIG. 18, in the present embodiment, on the upper surface of the disc 110, as the first tracks, two first tracks (SI5, SI6) are provided; and as the one or more second tracks, the above-described second tracks (SA1, SA2) are provided. The tracks including the first tracks and the second tracks are concentrically arranged in an order of the first track (SI5), the second track (SA1), the first track (SI6) and the second track (SA2) from the inner side to the outer side in the width direction (R).

The reflection slits of the second tracks (SA1, SA2) are arranged similar to the first embodiment.

On the other hand, the reflection slits of each of the first tracks (SI5, SI6) are arranged over the entire circumference of the disc 110 having an incremental pattern along the measurement direction (C). A pitch of the reflection slits of the first track (SI5) is P5, and a pitch of the reflection slits of the first track (SI6) is P6.

In the present embodiment, the pitch (P5) is set to be longer than the pitch (P6). In this example, the pitches are set so that P5=2×P6. Therefore, the number of the reflection slits of the first track (SI6) is twice the number of the reflection slits of the first track (SI5). A relation between the pitches is not necessarily required to be that one pitch is twice the other. Various kinds of relations between the pitches are possible such as that one pitch is set be three times, four times or five times of the other pitch, and the like.

In the present embodiment, a minimum length of the reflection slits of the second tracks (SA1, SA2) in the measurement direction (C) coincides with the pitch (P5). As a result, a resolution of a light receiving signal of the second light receiving arrays corresponding to the second tracks (SA1, SA2) coincides with the number of the reflection slits of the first track (SI5). The minimum length is not necessarily required to coincide with the pitch (P5). It is desirable that the number of the reflection slits of the first track (SI5) be formed the same as or more than the resolution of the light receiving signal of the second light receiving arrays corresponding to the second tracks (SA1, SA2).

Further, the lengths of the reflection slits of the second tracks (SA1, SA2) in the measurement direction (C) coincide with integer multiples of the pitch (P5). The lengths are not necessarily required to be integer multiples of the pitch (P5).

Further, a position of an end corresponding to the measurement direction (C) of each of the reflection slits of the second track (SA1) is offset from a position of an end corresponding to the measurement direction (C) of a reflection slit of the first track (SI5) to one side of the measurement direction (C). The offset amount corresponds to one quarter of the pitch (P5)(=(P5)/4). Similarly, a position of an end corresponding to the measurement direction (C) of each of the reflection slits of the second track (SA2) is offset from a position of an end corresponding to the measurement direction (C) of a reflection slit of the first track (SI5) to the other side of the measurement direction (C). The offset amount corresponds to one quarter of the pitch (P5). The offset amount is not necessarily required to be one quarter of the pitch (P5), but may take various values. Further, the end corresponding to the measurement direction (C) of the each of the reflection slits of the second tracks (SA1, SA2) and the end corresponding to the measurement direction (C) of the reflection slit of the first track (SI5) are not necessarily required to be offset in the measurement direction (C), but a case where the two are not offset in the measurement direction (C) is also possible.

Light Receiving Array

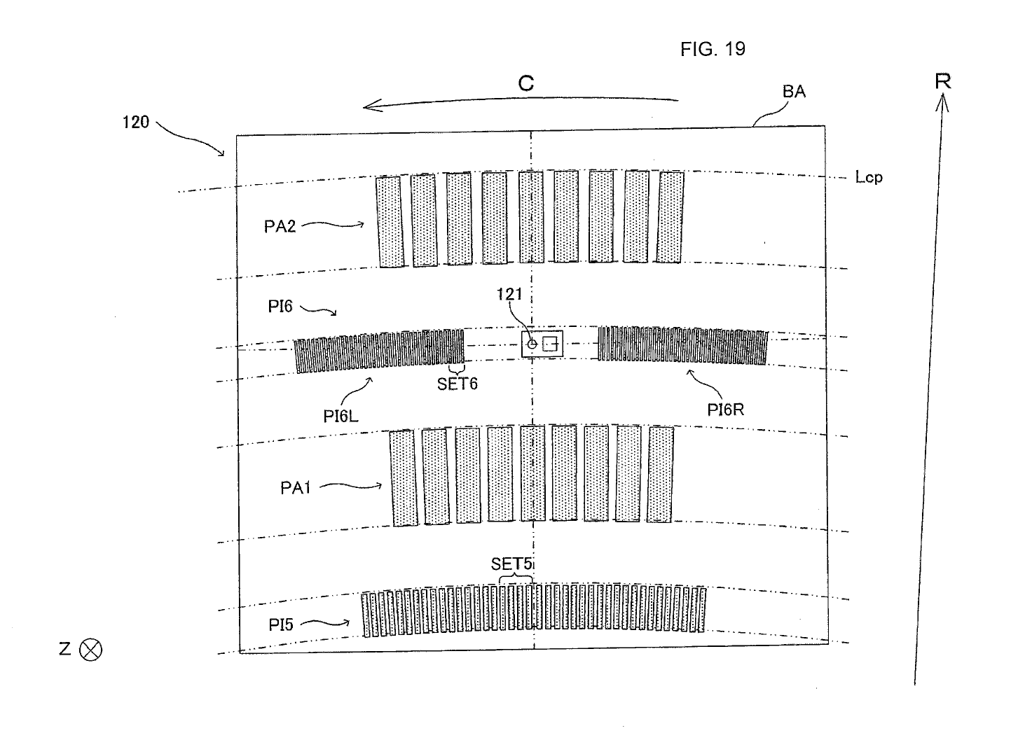

As illustrated in FIG. 19, in the present embodiment, on the lower surface of the substrate (BA) of the optical module 120, as the first light receiving arrays, two first light receiving arrays (PI5, PI6) are provided; and as the two second light receiving arrays, the above-described second light receiving arrays (PA1, PA2) are provided. The light receiving arrays including the first light receiving arrays and the second light receiving arrays are concentrically arranged in an order of the first light receiving array (PI5), the second light receiving array (PA1), the first light receiving array (PI6) and the second light receiving array (PA2) from the inner side to the outer side in the width direction (R).

Further, the light receiving arrays (PI5, PA1, PI6, PA2) are arranged in correspondence to the tracks (SI5, SA1, SI6, SA2). That is, the first light receiving array (PI5) is arranged in correspondence to the first track (SI5). The light receiving elements of the first light receiving array (PI5) receive light reflected by the reflection slits of the first track (SI5) to output a light receiving signal. Further, the first light receiving array (PI6) is arranged in correspondence to the first track (SI6). The light receiving elements of the first light receiving array (PI6) receive light reflected by the reflection slits of the first track (SI6) to output a light receiving signal. The second light receiving array (PA1), similar to the first embodiment, is arranged in correspondence to the second track (SA1). The second light receiving array (PA2), similar to the first embodiment, is arranged in correspondence to the second track (SA2).

The second light receiving arrays (PA1, PA2) are arranged similar to the first embodiment. That is, the second light receiving arrays (PA1, PA2) are arranged to be symmetrical in the width direction (R) around the light source 121. The second light receiving array (PA1) is arranged on the inner side in the width direction (R), and the second light receiving array (PA2) is arranged on the outer side in the width direction (R). The second light receiving arrays (PA1, PA2) may also be arranged to be asymmetric in the width direction (R) about the light source 121. However, for the convenience of the description, in the following, the case is described where the second light receiving arrays (PA1, PA2) are arranged to be symmetrical in the width direction (R) about the light source 121. Therefore, similar to the first embodiment, the distance between the second light receiving array (PA1) and the light source 121 and the distance between the second light receiving array (PA2) and the light source 121 are equal.

On the other hand, as described above, the first light receiving arrays (PI5, PI6) are arranged at mutually offset positions in the width direction (R). In this case, the first light receiving arrays (PI5, PI6) are arranged on an inner side and an outer side of the second light receiving arrays (PA1, PA2) in the width direction (R). In this example, the first light receiving array (PI6) is arranged on an inner side of the second light receiving arrays (PA1, PA2), and the first light receiving array (PI5) is arranged on an outer side of the second light receiving arrays (PA1, PA2). The first light receiving array (PI6) that is arranged on the inner side of the second light receiving arrays (PA1, PA2) has two light receiving arrays (PI6L, PI6R) that are arranged sandwiching the light source 121 therebetween in the measurement direction (C). That is, the first light receiving array (PI5) is arranged on the inner side of the light receiving array (PA1) in the width direction (R). The light receiving arrays (PI6L, PI6R) of the first light receiving array (PI6) are arranged sandwiching the light source 121 therebetween in the measurement direction (C) on the inner side of the second light receiving arrays (PA1, PA2) in the width direction (R).

Further, in the first light receiving arrays (PI5, PI6), by receiving light reflected by the corresponding first tracks (SI5, SI6), a light receiving signal is output. That is, the light receiving signal from the first light receiving arrays (PI5, PI6) corresponds to an example of a first light receiving signal.

The first light receiving array (PI5) is structured similar to the above-described first light receiving arrays (PI1, PI2). That is, in one pitch of the track (SI5) (one pitch in a projected image, that is, ε×P5), a set (indicated by “SET5” in FIG. 19) of a total of four light receiving elements is arranged, and multiple sets each including four light receiving elements are further arranged along the measurement direction (C). Therefore, from a large number of light receiving elements of the first light receiving array (PI5), four light receiving signals of which the phases are shifted by 90 degrees from each other are generated.

On the other hand, the first light receiving array (PI6) is also structured similar to the first light receiving array (PI5). That is, in one pitch of the track (SI6) (one pitch in a projected image, that is, ε×P6), a set (indicated by “SET6” in FIG. 19) of a total of four light receiving elements is arranged, and multiple sets each including four light receiving elements are further arranged along the measurement direction (C). Therefore, from a large number of light receiving elements of the first light receiving array (PI6), four light receiving signals of which the phases are shifted by 90 degrees from each other are generated.

As described above, in each of the first light receiving arrays (PI5, PI6), four light receiving signals (incremental signals) of which the phases are shifted by 90 degrees from each other are generated. For the convenience of the description, in the following, the four incremental signals of which the phases are shifted by 90 degrees from each other that are output from the first light receiving array (PI5) may also be collectively referred to as “one incremental signal.” Similarly, the four incremental signals of which the phases are shifted by 90 degrees from each other that are output from the first light receiving array (PI6) may also be collectively referred to as “one incremental signal.” The incremental signal from the first light receiving array (PI5) is also referred to as an “incremental signal (I5),” and the incremental signal from the first light receiving array (PI6) is also referred to as an “incremental signal (I6).”

Further, the incremental signal (I6) of the incremental pattern of the first track (SI6) that has a short pitch has a higher resolution as compared to the incremental signal (I5), and thus is also referred to as a “high incremental signal (I6).” Further, the incremental signal (I5) of the incremental pattern of the first track (SI5) that has a long pitch has a lower resolution as compared to the incremental signal (I6), and thus is also referred to as a “low incremental signal (I5).”

In the present embodiment, a case is described where four light receiving elements are included in one set corresponding to one pitch of the incremental pattern. However, the number of the light receiving elements included in one set is not particularly limited. For example, it is also possible that two light receiving elements are included in one set.

Controller

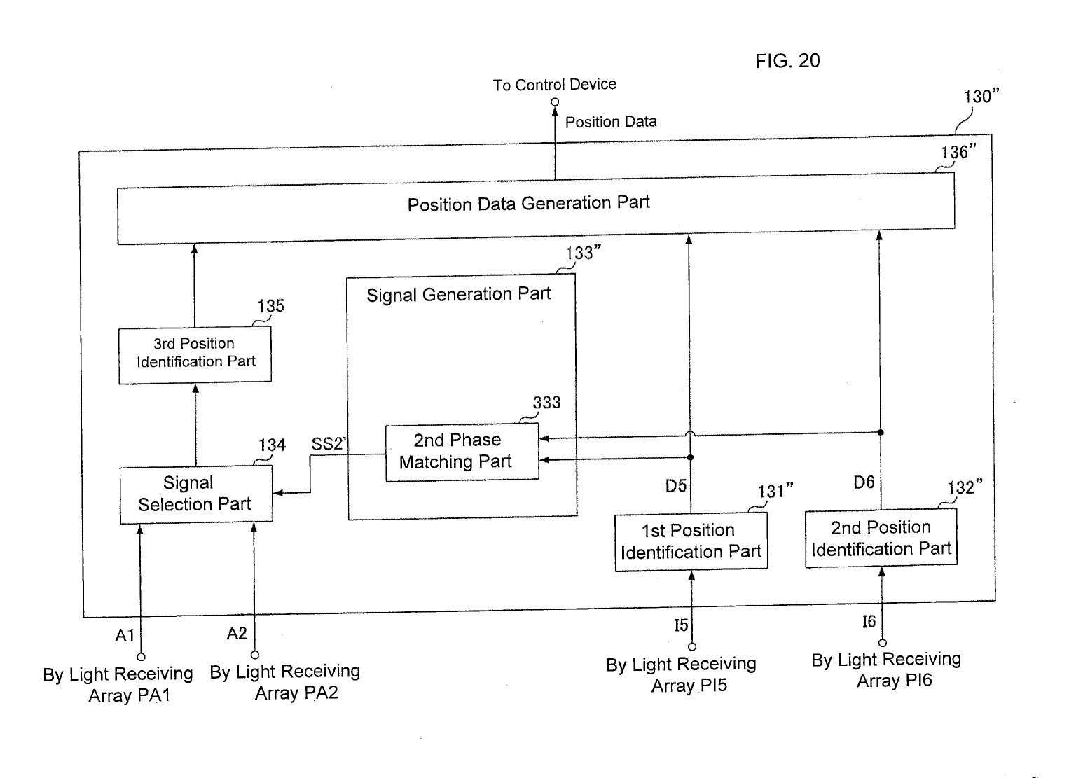

In the following, with reference to FIG. 20, with respect to an exemplary structure of the controller 130, an example of implementation using more specific functional blocks is described.

As illustrated in FIG. 20, the controller 130″ includes a first position identification part 131″, a second position identification part 132″, a signal generation part 133″, a signal selection part 134, a third position identification part 135 and a position data generation part 136″.

The second position identification part 132″ acquires from the first light receiving array (PI6) four high incremental signals (one incremental signal (I6)) of which the phases are shifted by 90 degrees from each other. Then, the second position identification part 132″ performs processing similar to the first position identification part 131, identifies a position (electrical angle) within one pitch of the first track (SI6), and generates and outputs second data representing the position.

The second data that the second position identification part 132″ outputs may be the above-generated second data itself However, in the following, a case is described where the second data that the second position identification part 132″ outputs is second data (D6) obtained after the above-generated second data is subjected to a multiplication process. In this case, a multiplication number of the second data is not particularly limited. However, in the following, a case is described where the multiplication number of the second data is 2″. That is, the second position identification part 132″ subjects the above-generated second data to a multiplication process in which the multiplication number is 2ⁿ, and outputs the second data (D6) after the multiplication process. The second data (D6) is a periodic signal representing a position within one pitch of the first track (SI6).

The first position identification part 131″ acquires from the first light receiving array (PI5) four low incremental signals (one incremental signal (I5)) of which the phases are shifted by 90 degrees from each other. Then, the first position identification part 131″ performs processing similar to the first position identification part 131, identifies a position (electrical angle) within one pitch of the first track (SI5), and generates and outputs first data representing the position.

The first data that the first position identification part 131″ outputs may be the above-generated first data itself. However, in the following, a case is described where the first data that the first position identification part 131″ outputs is first data (D5) obtained after the above-generated first data is subjected to a multiplication process. In this case, a multiplication number of the first data is not particularly limited. However, in the following, a case is described where the multiplication number of the first data is 2ⁿ⁺¹, and the resolution of the first data after the multiplication process and the resolution of the second data after the multiplication process are the same. That is, the first position identification part 131″ subjects the above-generated first data to a multiplication process in which the multiplication number is 2ⁿ⁺¹, and outputs the first data (D5) after the multiplication process. The first data (D5) is a periodic signal representing a position within one pitch of the first track (SI5).

Here, a case is described where eccentricity exists between the disc 110 and the shaft (SH), or the optical module 120 is arranged tilted in the rotation direction, or both the eccentricity exists between the disc 110 and the shaft (SH) and the optical module 120 is arranged tilted in the rotation direction. In this case, as described above, the first tracks (SI5, SI6) of the disc 110 oppose, in a inclined manner, the first light receiving arrays (PI5, PI6) that are arranged at mutually offset positions in the width direction (R). As a result, a phase shift from each other occurs in the incremental signals (I5, I6). In this case, a phase shift of the high incremental signal (I6) with respect to the absolute signals (A1, A2) is smaller than that of the low incremental signal (I5). In particular, as in the present embodiment, in the case where the first light receiving array (PI6) that is arranged on the inner side of the second light receiving arrays (PA1, PA2) is arranged at substantially the same position as the light source 121 in the in the width direction (R), the phase shift of the high incremental signal (I6) with respect to the absolute signals (A1, A2) is extremely small.

In the present embodiment, the controller 130″ selects one of the absolute signals (A1, A2) based on the incremental signals (I5, I6). As a result, it is possible to select an absolute signal while taking into consideration the above-described phase shift of the incremental signals (I5, I6). In this case, the controller 130″, based on the incremental signals (I5, I6), generates the above-described selection reference signal and, based on the selection reference signal, selects one of the absolute signals (A1, A2). A method for selecting an absolute signal by the controller 130″ is not limited to a method in which a selection reference signal is used, and is not particularly limited as long as it is a method in which the incremental signals (I5, I6) are used. However, for the convenience of the description, in the following, a case is described where the method for selecting an absolute signal by the controller 130″ is a method in which a selection reference signal is used.

The signal generation part 133″ generates a selection reference signal based on the incremental signals (I5, I6). As a result, a selection reference signal can be generated so that a phase shift thereof with respect to an absolute signal is reduced. In this case, the signal generation part 133″, based on the incremental signals (I5, I6), causes the phase of the selection reference signal to match the phase of the high incremental signal (I6). The processing content of the signal generation part 133″ is not limited to the above-described content. The processing content of the signal generation part 133″ is not particularly limited as long as it is content in which the selection reference signal is generated based on the incremental signals (I5, I6). However, for the convenience of the description, in the following, a case is described where the signal generation part 133″, based on the incremental signals (I5, I6), causes the phase of the selection reference signal to match the phase of the high incremental signal (I6).

That is, the signal generation part 133′ is provided with a second phase matching part 333.

The second phase matching part 333, based on the incremental signals (I5, I6), causes the phase of the selection reference signal to match the phase of the high incremental signal (I6). As a result, a selection reference signal can be generated so that a phase shift thereof with respect to an absolute signal is reduced. More specifically, the second phase matching part 333 acquires the first data (D5) from the first position identification part 131″ and acquires the second data (D6) from the second position identification part 132″. Then, the second phase matching part 333, based on the acquired first data (D5) and second data (D6), performs a subtraction process that calculates a difference between the first data (D5) and the second data (D6) and generates a selection reference signal (SS2). That is, the selection reference signal (SS2) is a pulse waveform that is synchronized with phase variation of the second data (D6) (high incremental signal (I6)), and is represented by the following Formula 10.

SS2=mod{(D5+2ⁿ⁺¹)−D6, 2ⁿ⁺¹} Formula 10

Here, mod{(D5+2ⁿ⁺¹)−D6, 2ⁿ⁺¹} is a function that means a remainder when (D5+2ⁿ⁺¹)−D6 is divided by 2ⁿ⁺¹.

Thereafter, the second phase matching part 333 performs a process in which an amplitude of the generated selection reference signal (SS2) is set to “1” and outputs a selection reference signal (SS2′) after the process to the signal selection part 134. That is, the selection reference signal (SS2′) is a pulse waveform that is synchronized with phase variation of the second data (D6) (high incremental signal (I6)), and is represented by the following Formula 11.

SS2′=ROUND{(SS2+2ⁿ⁻¹)/2ⁿ, 0} Formula 11

Here, ROUND{(SS2+2ⁿ⁻¹)/2ⁿ, 0} is a function that means to round (SS2+2ⁿ⁻¹)/2ⁿ to a nearest integer.

The selection reference signal that the second phase matching part 333 outputs to the signal selection part 134 is not limited to the selection reference signal (SS2′) after the process, but may also be the selection reference signal (SS2). However, for the convenience of the description, in the following, a case is described where the selection reference signal that the second phase matching part 333 outputs to the signal selection part 134 is the selection reference signal (SS2′) after the process.

Further, the processes and the like that are performed by the second phase matching part 333 of the signal generation part 133″ are not limited to the examples of division of the processes. For example, these processes may be performed by two or more processing parts that are further subdivided.

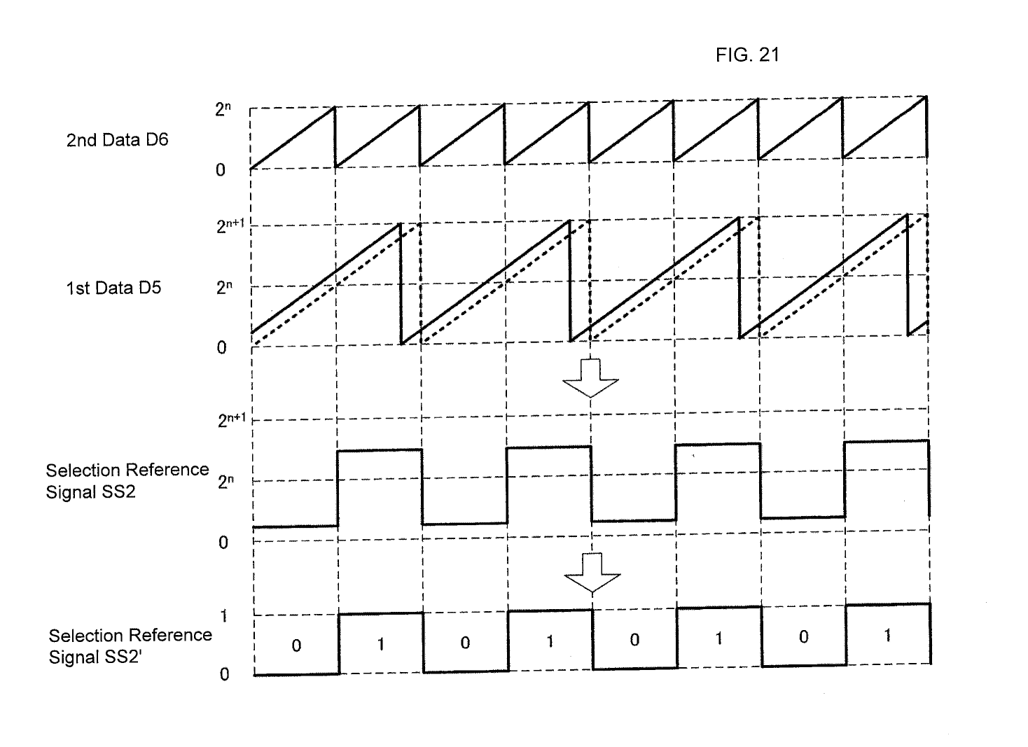

FIG. 21 illustrates an example of the selection reference signals (SS2, SS2′).

In FIG. 21, a saw-tooth waveform of an upper row is a waveform of the second data (D6). A saw-tooth waveform (solid line) of a second row from top is a waveform of the first data (D5) of which the phase is more retarded than that in the case where a phase shift is not occurring (dashed line).

A pulse waveform of a third row from top is a waveform of the selection reference signal (SS2) after performing the subtraction process based on the first data (D5) that illustrates the waveform in the second row from top and the second data (D6) that illustrates the waveform in the uppermost row. A pulse waveform of a lowest row is a waveform of the selection reference signal (SS2′) after performing the process in which the amplitude of the selection reference signal (SS2) that illustrates the waveform in the third row from top is set to “1.”

Although not illustrated in drawings, the waveform of the absolute signal (A1) has an On-Off transition when an amplitude value of the selection reference signal (SS2′) is “1,” and the waveform of the absolute signal (A2) has an On-Off transition when the amplitude value of the selection reference signal (SS2′) is “0.” A correspondence relationship between the amplitude values “0” and “1” of the selection reference signal (SS2′) and the On-Off transitions of the absolute signals (A1, A2) may be reversed.

That is, when the amplitude value of the selection reference signal (SS2′) is “0,” the amplitude of the absolute signal (A1) is more stable than that of the absolute signal (A2). On the other hand, when the amplitude value of the selection reference signal (SS2′) is “1,” the amplitude of the absolute signal (A2) is more stable than that of the absolute signal (A1). Here, the amplitude values “0” and “1” of the selection reference signal (SS2′) are for a same phase range (180 degrees in electrical angle), but may also be for different phase ranges, and further the phase ranges may be other than 180 degrees in electrical angle.

Therefore, when the amplitude value of the selection reference signal (SS2′) is “0,” the absolute signal (A1) can be selected as the absolute position identification absolute signal. On the other hand, when the amplitude value of the selection reference signal (SS2′) is “1,” the absolute signal (A2) can be selected as the absolute position identification absolute signal. As a result, the absolute position can be identified using an absolute signal that is not in a region such as a changing point of a detection pattern where the amplitude of the detection pattern is unstable. Therefore, the detection accuracy can be improved.

As illustrated in FIG. 20, the signal selection part 134 according to the present embodiment acquires the selection reference signal (SS2′) from the second phase matching part 333 and acquires the absolute signals (A1, A2) from the second light receiving arrays (PA1, PA2). Then, the signal selection part 134, based on the acquired selection reference signal (SS2′), selects one of the acquired absolute signals (A1, A2). That is, the signal selection part 134 selects the absolute signal (A1) when the amplitude value of the selection reference signal (SS2′) is “0,” and selects the absolute signal (A2) when the amplitude value of the selection reference signal (SS2′) is “1.” As a result, an absolute signal that is not in a region such as a changing point of a detection pattern where the amplitude of the detection pattern is unstable can be selected. Then, the signal selection part 134 outputs the above-selected one of the absolute signals to the third position identification part 135.

The third position identification part 135, based on the one of the absolute signals that is acquired from the signal selection part 134, identifies the above-described first absolute position as described above, and outputs the above-described third data to the position data generation part 136″.

The position data generation part 136″, based on one of the absolute signals (A1, A2) and one or more of the incremental signals (I5, I6), calculates the absolute position, and generates and outputs the position data that represents the absolute position to the control device (CT). That is, the position data generation part 136″ corresponds to an example of a means that generates position data.

The generation method of the position data by the position data generation part 136″ is not particularly limited as long as it is a method that uses one of the absolute signals (A1, A2) and one or more of the incremental signals (I5, I6). However, for the convenience of the description, in the following, a case is described where the position data generation part 136″, based on one of the absolute signals (A1, A2) and the incremental signals (I5, I6), generates the position data using a method as described below.

That is, the position data generation part 136″ acquires the third data from the third position identification part 135, and acquires the first data (D5) from the first position identification part 131″ and the second data (D6) from the second position identification part 132″. Then, the position data generation part 136″, by superimposing the first data (D5) (relative position) on the third data (first absolute position), calculates an absolute position that is higher in accuracy than the first absolute position. Thereafter, the position data generation part 136″, by superimposing the second data (D6) (relative position) on the above-calculated absolute position, calculates an absolute position that is further higher in resolution than the absolute position, and generates position data that represents the absolute position.

The processes and the like that are performed by the first position identification part 131″, the second position identification part 132″, the signal generation part 133″, the signal selection part 134, the third position identification part 135 and the position data generation part 136″ of the controller 130″ are not limited to the examples of division of the processes. For example, these processes may be performed by one processing part or may be performed by seven or more processing parts that are further subdivided.

Example of Position Data Generation Method of Encoder

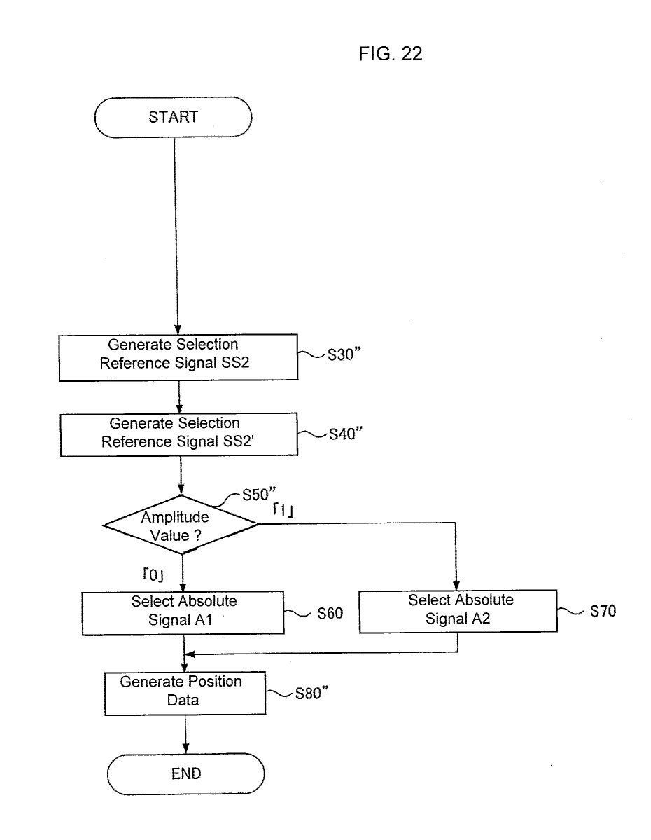

With reference to FIG. 22, an example is described of control procedures that the controller 130″ executes related to a position data generation method of the encoder 100 according to the present embodiment.

As illustrated in FIG. 22, at step (S30″), the controller 130″, via the second phase matching part 333, generates the selection reference signal (SS2) by executing the process represented by the above Formula 10 based on the first data (D5) generated by the first position identification part 131″ and the second data (D6) generated by the second position identification part 132″.

Thereafter, at step (S40″), the controller 130″, via the second phase matching part 333, generates the selection reference signal (SS2′) by executing the process represented by the above Formula 11 based on the selection reference signal (SS2) generated at the above step (S30″).

Then, at step (S50″), the controller 130″ judges the amplitude value of the selection reference signal (SS2′) generated at the above step (S40″). In this case, when the amplitude value of the selection reference signal (SS2′) is “0,” the processing proceeds to step (S60), and the controller 130″, via the signal selection part 134, selects the absolute signal (A1). On the other hand, when the amplitude value of the selection reference signal (SS2′) is “1,” the processing proceeds to step (S70), and the controller 130″, via the signal selection part 134, selects the absolute signal (A2). After step (S60) or step (S70) is executed, the processing proceeds to step (S80″).

At step (S80″), the controller 130″, via the position data generation part 136″, generates the position data as described above based on the third data, the first data (D5) and the second data (D6), the third data being generated by the third position identification part 135 based on the one of the absolute signals that is selected at the above step (S60) or step (S70), the first data (D5) being generated by the first position identification part 131″, and the second data (D6) being generated by the second position identification part 132″. As a result, the process represented by the flowchart illustrated in FIG. 22 is completed.

In FIG. 22, steps (S30″, S40″) correspond to an example of a signal generation step and correspond to an example of a second phase matching step. Further, steps (S60, 70) correspond to an example of a signal selection step. Further, step (S80″) corresponds to an example of a position data generation step.

Examples of Effects of Present Embodiment

As described above, according to the present embodiment, the same effects as those of the first and second embodiments can be obtained. Further, in the present embodiment, the first light receiving arrays (PI5, PI6) are arranged on an inner side and an outer side of the second light receiving arrays (PA1, PA2) in the width direction (R). In such an arrangement, the high incremental signal (I6) of the first light receiving array (PI6) that is arranged on the inner side of the second light receiving arrays (PA1, PA2) has a smaller phase shift with respect to the absolute signals (A1, A2) than the low incremental signal (I5) of the first light receiving array (PI5) that is arranged on the outer side of the second light receiving arrays (PA1, PA2). In the present embodiment, the second phase matching part 333 causes the phase of the selection reference signal (SS2′) to match the phase of the high incremental signal (I6). As a result, the selection reference signal (SS2′) can be generated so that a phase shift thereof with respect to the absolute signals (A1, A2) is reduced.

Further, in the present embodiment, the first light receiving array (PI6) that is arranged on the inner side of the second light receiving arrays (PA1, PA2) in the width direction (R) has the light receiving arrays (PI6L, PI6R) that are arranged sandwiching the light source 121 therebetween in the measurement direction (C). This allows the first light receiving array (PI6) to be arranged at substantially the same position as the light source 121 in the width direction (R). As a result, the phase shift of the high incremental signal (I6) with respect to the absolute signals (A1, A2) can be reduced as much as possible. Therefore, the second phase matching part 333 causes the phase of the selection reference signal (SS2′) to match the phase of the high incremental signal (I6), and thereby the selection reference signal (SS2′) can be generated so that a phase shift thereof with respect to the absolute signals (A1, A2) can be reduced as much as possible.

### Modified Embodiments

In the above, the embodiments have been described with reference to the drawings. However, the scope of the technical ideas described in the appended claims is not limited to the embodiments. It is clear that, for a person of ordinary skill in the field to which the above-described embodiments, within the scope of the technical ideas, various variations, modifications, combinations and the like can be conceived. Therefore, technologies resulting from performing these variations, modifications, combinations and the like naturally fall within the scope of the technical ideas. In the following, such modified embodiments and the like are described. Structural elements having substantially the same functions as in the above-described embodiments are in principle denoted using the same reference numerals, and redundant description thereof is omitted as appropriate.

Another Example of Formation of Light Receiving Array

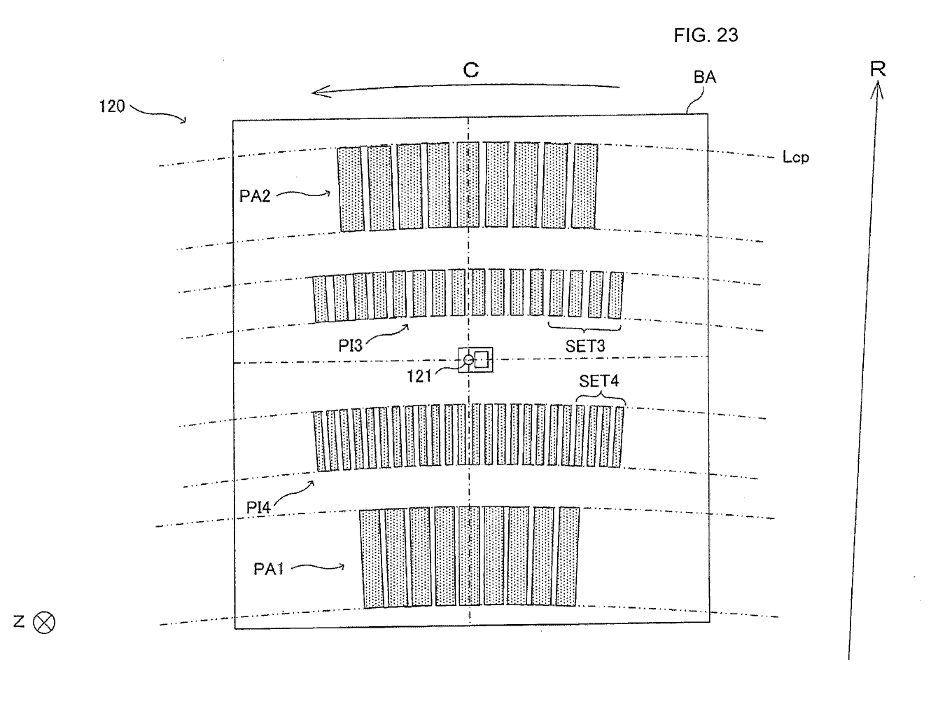

In the second embodiment, the case is described where the first light receiving array (PI3) is arranged between the inner side light receiving array (PA1) and the light source 121 in the width direction (R), and the first light receiving array (PI4) is arranged between the light source 121 and the outer side light receiving array (PA2) in the width direction (R) (see FIG. 13). However, for example, as illustrated in FIG. 23, it is also possible that the first light receiving array (PI3) is arranged between the light source 121 and the outer side light receiving array (PA2) in the width direction (R), and the first light receiving array (PI4) is arranged between the inner side light receiving array (PA1) and the light source 121.

Although not illustrated in drawings, in this case, on the upper surface of the disc 110, the tracks including the first tracks and the second tracks are concentrically arranged in an order of the second track (SA1), the first track (SI4), the first track (SI3) and the second track (SA2) from the inner side to the outer side in the width direction (R).

It is desirable that the structure of the second embodiment be adopted when robustness with respect to eccentricity of the high incremental signal (I4) is to be improved and the structure of the present modified embodiment be adopted when robustness with respect to eccentricity of the low incremental signal (I3) is to be improved.

Yet Another Example of Formation of Light Receiving Array

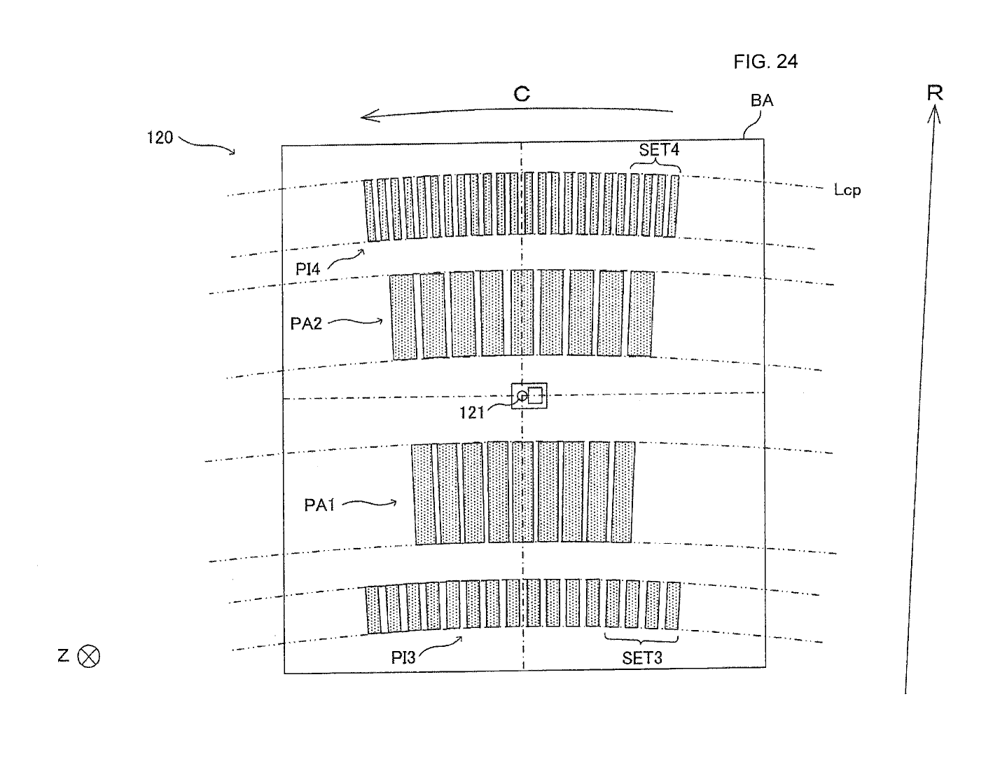

Further, in the second embodiment, the case is described where the first light receiving arrays (PI3, PI4) are arranged sandwiching the light source 121 therebetween on the inner side of the second light receiving arrays (PA1, PA2) in the width direction (R) (see FIG. 13). However, for example, as illustrated in FIG. 24, it is also possible that the second light receiving arrays (PA1, PA2) are arranged sandwiching the light source 121 therebetween on the inner side of the first light receiving arrays (PI3, PI4) in the width direction (R).

In this case, the following effects are obtained. That is, the incremental signals output from the second light receiving arrays (PA1, PA2) form a basis for the final absolute position. Therefore, correctness and responsiveness are sought in order to improve accuracy. Therefore, the arrangement positions of the second light receiving arrays (PA1, PA2) are an important factor in improving the accuracy. In the present modified embodiment, the second light receiving arrays (PA1, PA2) are arranged sandwiching the light source 121 therebetween on the inner side of the first light receiving arrays (PI3, PI4) in the width direction (R). Therefore, the second light receiving arrays (PA1, PA2) that have a relatively large impact on the accuracy of the absolute position can be arranged close to the light source 121. As a result, the responsiveness can be improved and thus the accuracy of the absolute position can be improved.

In the case illustrated in FIG. 24, it is also possible that the position of the first light receiving array (PI3) and the positioned of the first light receiving array (PI4) are reversed.

Further, with respect to the first embodiment, the arrangement of the respective light receiving arrays may be modified in the same spirit as the present modified embodiment.

Yet Another Example of Formation of Light Receiving Array

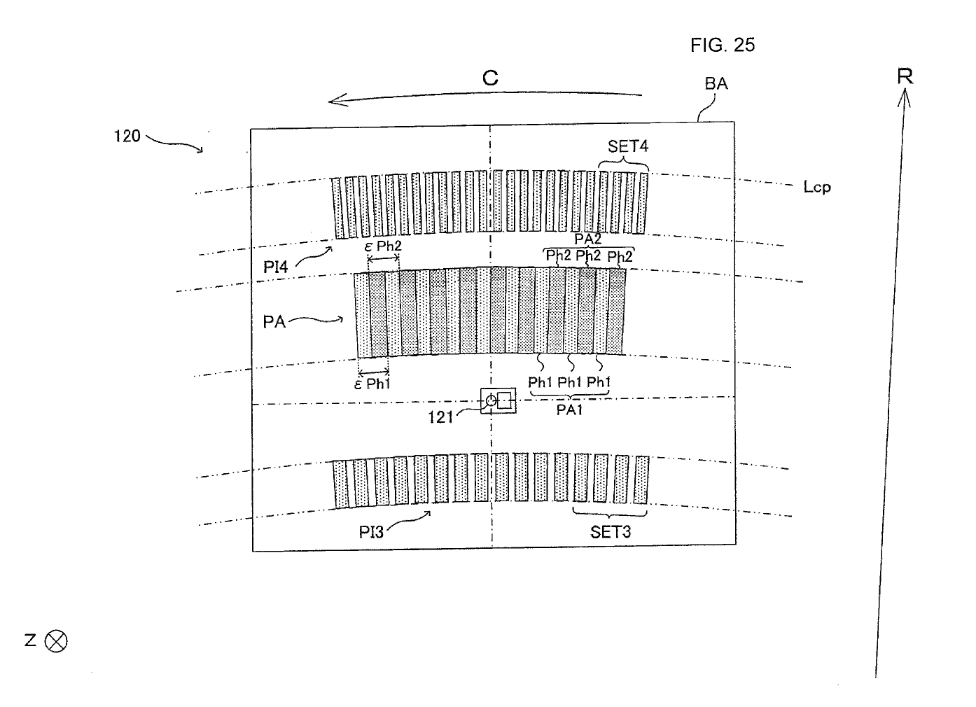

Further, in the second embodiment, the case is described where the second light receiving arrays (PA1, PA2) are arranged at offset positions in the width direction (R) (see FIG. 13). However, for example, as illustrated in FIG. 25, it is also possible to structure the second light receiving arrays (PA1, PA2) as a single light receiving array (PA) by alternately arranging, along the measurement direction (C), the light receiving elements (Ph1, Ph2) that structure the respective second light receiving arrays (PA1, PA2).

In this example, an arrangement pitch of the light receiving elements (Ph1) and an arrangement pitch of the light receiving elements (Ph2) both correspond to the minimum length (pitch (Ph1)) of the reflection slits of the second tracks (SA1, SA2) in the measurement direction (C) (the minimum length in the projected image, that is, ε×Ph1), and the length of the light receiving elements (Ph1, Ph2) in the measurement direction (C) coincides with one half of ε×Ph1. As a result, the second light receiving arrays (PA1, PA2) are offset from each other by a length of one half of one bit (corresponding to one half of the pitch (Ph1)) in the measurement direction (C). Similar to the second embodiment, when an absolute position according to the second track (SA1) corresponds to a transition region of a bit pattern, the absolute signal from the second track (SA2) can be used to calculate an absolute position, and vice versa.

Although not illustrated in drawings, in this case, on the upper surface of the disc 110, the tracks including the first tracks and a second track are concentrically arranged in an order of the first track (SI3), the second track and the first track (SI4), from the inner side to the outer side in the width direction (R). The second track has the same structure as one of the second tracks (SA1, SA2).

In the present modified embodiment, the second light receiving arrays (PA1, PA2) are structured as the single light receiving array (PA). As a result, the second track and the second light receiving array (PA) both can be single members. Therefore, the disc 110 and the optical module 120, and thus the encoder 100, can be miniaturized.

In the case illustrated in FIG. 25, it is also possible that the position of the first light receiving array (PI3) and the positioned of the first light receiving array (PI4) are reversed.

Further, with respect to the first or the third embodiment, the arrangement of the respective light receiving arrays may be modified in the same spirit as the present modified embodiment.

### Exemplary Structure of Encoder

In the following, with reference to FIG. 26, a structural example is described of the encoder 100 that realizes the processing performed by the controllers (130, 130′, 130″) according to the above-described embodiments and modified embodiments.

As illustrated in FIG. 26, the encoder 100, for example, includes a CPU 901, a ROM 903, a RAM 905, a control device 907 such as an application specific integrated circuit (such as an ASIC or an FPGA that is built for a specific application) or other electrical circuits, an input device 913, an output device 915, a storage device 917, a drive 919, a connection port 921, and a communication device 923. These structural elements are connected via a bus 909 and an input/output interface 911 in a manner capable of transmitting a signal between each other.

A program can be stored in a recording device such as the ROM 903, the RAM 905, or the storage device 917.

Further, the program can also be temporarily or permanently recorded in a removable storage medium 925 such as a magnetic disk (such as a flexible disk), an optical disc (such as various CD, MO discs, or DVD), or a semiconductor memory. Such a removable storage medium 925 can be provided as a so-called package software. In this case, the program recorded in the removable storage medium 925 is read by the drive 919 and may be recorded in the recording device via the input/output interface 911, the bus 909 or the like.

Further, the program, for example, can also be recorded at a download site, another computer, another recording device and the like (not illustrated in the drawings). In this case, the program transmitted via a network (NW) such as a LAN or the Internet, and the communication device 923 receives the program. The communication device 923 may record the received program in the recording device via the input/output interface 911 and the bus 909.

Further, the program, for example, can also be recorded in an appropriate external connection device 927. In this case, the program may be transmitted via the appropriate connection port 921 and recorded in the recording device via the input/output interface 911, the bus 909 and the like.

Then, the CPU 901 can realize the processing performed by the controllers 130, 130′, 130″ and the like by executing various processes according to the program recorded in the recording device. In this case, the CPU 901, for example, may directly read out the program from the recording device and execute the program, or temporarily load the program to the RAM 905 and then execute the program. Further, for example, when the program is received via the communication device 923, the drive 919 and the connection port 921, the CPU 901 may directly execute the received program without recording the program in the recording device.

Further, when necessary, the CPU 901 may perform various processes based on signals or information input from the input device 913 such as a mouse, keyboard and microphone (not illustrated in the drawings).

Then, the CPU 901 may output a result resulting from executing the above processing from the output device 915 such as a display device or an audio output device. Further, when necessary, the CPU 901 may transmit the processing result via the communication device 923 and the connection port 921, and may also record the processing result in the recording device or the removable storage medium 925.

In the above, the case is described where the processing performed by the controllers 130, 130′, 130″ and the like is implemented by the program that the CPU 901 executes. However, it is also possible that a part or the whole of the processing is executed by the control device 907.

In the above description, “perpendicular” does not mean “perpendicular” in a strict sense. That is, “perpendicular” means “substantially perpendicular” when tolerances and errors in design and in manufacturing are within allowed ranges.

In the above description, “parallel” does not mean “parallel” in a strict sense. That is, “parallel” means “substantially parallel” when tolerances and errors in design and in manufacturing are within allowed ranges.

In the above description, “coincide,” “equal,” “uniform,” identical” and “same” do not mean “coincide,” “equal,” “uniform,” identical” and “same” in a strict sense. That is, “coincide,” “equal,” “uniform,” identical” and “same” mean “substantially coincide,” “substantially equal,” “substantially uniform,” identical” and “substantially same” when tolerances and errors in design and in manufacturing are within allowed ranges.

In the above description, “symmetrical” does not mean “symmetrical” in a strict sense. That is, “symmetrical” means “substantially symmetrical” when tolerances and errors in design and in manufacturing are within allowed ranges.

The arrows illustrated in FIGS. 2, 6, 4, 20 and 26 are intended to illustrate an example of flows of signals and are not intended to limit the flow directions of the signals.

The steps described in the flowcharts illustrated in FIGS. 11, 17 and 22 include, of course, processes that are chronologically performed in the order being described, and also include processes that are not necessarily to be chronologically performed but may be performed in parallel or individually. Further, even for steps that are chronologically performed, in some cases, the order to perform the steps may be appropriately modified.

In addition to those already described above, techniques according to the above-described embodiments and modified embodiments may be appropriately combined and used.

Although not illustrated, various modifications may be made to the above-described embodiments and modified embodiments within the scope without departing from the spirit thereof.

In an encoder, increasing detection accuracy of an absolute position and improving reliability of position data are sought.

An encoder, a servo system and a position data generation method of the encoder according to embodiments of the present invention improve reliability of position data.

As in the embodiments described below, an encoder includes two light receiving arrays that each receive light reflected or transmitted by a corresponding track among two tracks each having an absolute pattern and respectively output light receiving signals (also referred to as “absolute signals”) having mutually different phases.

In such an encoder, the absolute patterns of the two tracks that are provided on a disc are arranged offset from each other in a measurement direction by, for example, a half pitch. Or, instead of that the two absolute patterns are arranged offset from each other in the measurement direction, it is also possible that the two light receiving arrays that are provided on an optical module are arranged offset from each other in the measurement direction. As a result, the absolute signals from the two light receiving arrays are different in phase by, for example, 180 degrees from each other. Therefore, by selectively using an absolute signal that is not in an unstable region such as a changing point of a detection pattern to detect an absolute position, detection accuracy can be improved.

Further, as in the embodiments described below, an encoder includes, in addition to the two light receiving arrays according to the absolute patterns, multiple light receiving arrays that receive light reflected or transmitted by corresponding tracks among multiple tracks that each have an incremental pattern to respectively output light receiving signals (also referred to as “incremental signals”).

In such an encoder, the light receiving arrays according to the incremental patterns provided on an optical module are arranged offset from each other in a width direction perpendicular to the measurement direction.

Here, it is possible that, in the encoder, there exists eccentricity the disc and a shaft, or the optical module is arranged tilted, for example, in a direction of rotation about an optical axis. In such a case, the tracks according to the incremental patterns provided on the disc oppose in an inclined manner the light receiving arrays according to the incremental patterns. As a result, there is a possibility that a phase shift occurs between the incremental signals from the light receiving arrays according to the incremental patterns and affects the detection accuracy of the absolute position.

However, according to study by the inventors, it is found that, by selecting one of the two absolute signals (the absolute signal to be used in detecting the absolute position) based on the incremental signals, an absolute signal can be selected while taking into consideration the above-described phase shift.

According to one aspect of the present invention, an encoder includes: a disc that is fixed on a rotating body; multiple first tracks that are provided on the disc and each have an incremental pattern along a measurement direction; one or more second tracks that are provided on the disc and each have an absolute pattern along the measurement direction; a light source that is structured to emit light to the first tracks and the second tracks; multiple first light receiving arrays that are arranged at mutually offset positions in a width direction perpendicular to the measurement direction and are structured to respectively receive light reflected or transmitted by the corresponding first tracks to respectively output first light receiving signal; two second light receiving arrays that are structured to respectively receive light reflected or transmitted by the corresponding second tracks to respectively output second light receiving signals having mutually different phases; and a position data generation part that is structured to generate position data of the rotating body based on one or more of the first light receiving signals and one of the two second light receiving signals that is selected based on the first light receiving signal.

According to another aspect of the present invention, a servo system includes: a motor of which a rotor rotates with respect to a stator; the encoder that is structured to detect at least one of a position and speed of the rotor; and a control device that is structured to control the motor based on a detection result of the encoder.

According to yet another aspect of the present invention, a position data generation method of an encoder is provided. The encoder includes: a disc that is fixed on a rotating body; multiple first tracks that are provided on the disc and each have an incremental pattern along a measurement direction; one or more second tracks that are provided on the disc and each have an absolute pattern along the measurement direction; a light source that is structured to emit light to the first tracks and the second tracks; multiple first light receiving arrays that are arranged at mutually offset positions in a width direction perpendicular to the measurement direction and are structured to respectively receive light reflected or transmitted by the corresponding first tracks to respectively output first light receiving signals; and two second light receiving arrays that are structured to respectively receive light reflected or transmitted by the corresponding second tracks to respectively output second light receiving signals having mutually different phases. In the position data generation method of the encoder, position data of the rotating body is generated based on one or more of the first light receiving signals and one of the two second light receiving signals that is selected based on the first light receiving signals.

Further, according to yet another aspect of the present invention, an encoder includes: a disc that is fixed on a rotating body; multiple first tracks that are provided on the disc and each have an incremental pattern along a measurement direction; one or more second tracks that are provided on the disc and each have an absolute pattern along the measurement direction; a light source that is structured to emit light to the first tracks and the second tracks; multiple first light receiving arrays that are arranged at mutually offset positions in a width direction perpendicular to the measurement direction and are structured to respectively receive light reflected or transmitted by the corresponding first tracks to respectively output first light receiving signal; two second light receiving arrays that are structured to respectively receive light reflected or transmitted by the corresponding second tracks to respectively output second light receiving signals having mutually different phases; and a means that generates position data of the rotating body based on one or more of the first light receiving signals and one of the two second light receiving signals that is selected based on the first light receiving signals.

Further, according to still another aspect of the present invention, a position data generation method of an encoder is provided. The encoder includes: a disc that is fixed on a rotating body; multiple first tracks that are provided on the disc and each have an incremental pattern along a measurement direction; one or more second tracks that are provided on the disc and each have an absolute pattern along the measurement direction; a light source that emits light to the first tracks and the second tracks; multiple first light receiving arrays that are arranged at mutually offset positions in a width direction perpendicular to the measurement direction and respectively receive light reflected or transmitted by the corresponding first tracks to respectively output first light receiving signals; and two second light receiving arrays that respectively receive light reflected or transmitted by the corresponding second tracks to respectively output second light receiving signals having mutually different phases. The position data generation method of the encoder includes: a signal generation step at which a selection reference signal is generated based on the first light receiving signals; a signal selection step at which one of the two second light receiving signals is selected based on the selection reference signal; and a position data generation step at which position data of the rotating body is generated based on one or more of the first light receiving signals and one of the two second light receiving signals that is selected at the signal selection step.

According to still another aspect of the present invention, in the position data generation method of the encoder, at the position data generation step, the position data is generated based on the respective first light receiving signals of the first light receiving arrays that respectively receive light reflected or transmitted by corresponding first tracks among the first tracks that respectively have incremental patterns with mutually different pitches and based on the one of the second light receiving signals.

According to still another aspect of the present invention, in the position data generation method of the encoder, at the signal generation step, the selection reference signal is generated based on the first light receiving signals including the respective first light receiving signals of the one or more first light receiving arrays that are arranged sandwiching the light source therebetween in the width direction on an inner side of the two second light receiving arrays.

According to still another aspect of the present invention, in the position data generation method of the encoder, the signal generation step includes: an average signal generation step at which an average signal is generated resulting from averaging the respective first light receiving signals of the two first light receiving arrays that are arranged sandwiching the light source therebetween in the width direction on an inner side of the two second light receiving arrays; and a first phase matching step at which a phase of the selection reference signal is caused to match a phase of the average signal based the average signal and the first light receiving signals.

According to still another aspect of the present invention, in the position data generation method of the encoder, at the average signal generation step, the average signal is generated resulting from averaging the respective first light receiving signals of the two first light receiving arrays that are arranged to be symmetrical about the light source in the width direction; and at the signal selection step, one of the two second light receiving signals of the two second light receiving arrays that are arranged to be symmetrical about the light source in the width direction is selected.

According to still another aspect of the present invention, in the position data generation method of the encoder, the signal generation step includes a second phase matching step at which, based on the respective first light receiving signals of the two first light receiving arrays that are arranged on an inner side and an outer side of the two second light receiving arrays in the width direction, a phase of the selection reference signal is caused to match a phase of the first light receiving signal of the first light receiving array that is arranged on the inner side.

According to still another aspect of the present invention, in the position data generation method of the encoder, at the second phase matching step, a phase of the selection reference signal is caused to match a phase of the first light receiving signal of the first light receiving array that is arranged on the inner side and that has two light receiving arrays that are arranged sandwiching the light source therebetween in the measurement direction.

According to still another aspect of the present invention, in the position data generation method of the encoder, at the signal generation step, the selection reference signal is generated based on the first light receiving signals of the first light receiving arrays that respectively receive light reflected by the first tracks that reflect light emitted by the light source; at the signal selection step, one of the two second light receiving signals of the two second light receiving arrays that respectively receive light reflected by the second tracks that reflect light emitted by the light source is selected based on the selection reference signal; and at the position data generation step, the position data is generated based on one or more of the first light receiving signals and one of the second light receiving signals that is selected at the signal selection step.

Further, according to yet another aspect of the present invention, an encoder control device is provided in an encoder. The encoder includes: a disc that is fixed on a rotating body; multiple first tracks that are provided on the disc and each have an incremental pattern along a measurement direction; one or more second tracks that are provided on the disc and each have an absolute pattern along the measurement direction; a light source that emits light to the first tracks and the second tracks; multiple first light receiving arrays that are arranged at mutually offset positions in a width direction perpendicular to the measurement direction and respectively receive light reflected or transmitted by the corresponding first tracks to respectively output first light receiving signals; and two second light receiving arrays that respectively receive light reflected or transmitted by the corresponding second tracks to respectively output second light receiving signals having mutually different phases. The encoder control device includes: a signal generation part that generates a selection reference signal based on the first light receiving signals; a signal selection part that selects one of the two second light receiving signals based on the selection reference signal; and a position data generation part that generate position data of the rotating body based on one or more of the first light receiving signals and one of the second light receiving signals that is selected by the signal selection part.

According to still another aspect of the present invention, in the encoder control device, the position data generation part generates the position data based on the respective first light receiving signals of the first light receiving arrays that respectively receive light reflected or transmitted by corresponding first tracks among the first tracks that respectively have incremental patterns with mutually different pitches and based on the one of the second light receiving signals.

According to still another aspect of the present invention, in the encoder control device, the signal generation part generates the selection reference signal based on the first light receiving signals including the respective first light receiving signals of the one or more first light receiving arrays that are arranged sandwiching the light source therebetween in the width direction on an inner side of the two second light receiving arrays.

According to still another aspect of the present invention, in the encoder control device, the signal generation part includes: an average signal generation part that generates an average signal resulting from averaging the respective first light receiving signals of the two first light receiving arrays that are arranged sandwiching the light source therebetween in the width direction on an inner side of the two second light receiving arrays; and a first phase matching part that causes a phase of the selection reference signal to match a phase of the average signal based the average signal and the first light receiving signals.

According to still another aspect of the present invention, in the encoder control device, the average signal generation part generates the average signal resulting from averaging the respective first light receiving signals of the two first light receiving arrays that are arranged to be symmetrical about the light source in the width direction; and the signal selection part selects one of the two second light receiving signals of the two second light receiving arrays that are arranged to be symmetrical about the light source in the width direction.

According to still another aspect of the present invention, in the encoder control device, the signal generation part includes a second phase matching part that, based on the respective first light receiving signals of the two first light receiving arrays that are arranged on an inner side and an outer side of the two second light receiving arrays in the width direction, causes a phase of the selection reference signal to match a phase of the first light receiving signal of the first light receiving array that is arranged on the inner side.

According to still another aspect of the present invention, in the encoder control device, the second phase matching part causes a phase of the selection reference signal to match a phase of the first light receiving signal of the first light receiving array that is arranged on the inner side and that has two light receiving arrays that are arranged sandwiching the light source therebetween in the measurement direction.

According to still another aspect of the present invention, in the encoder control device, the signal generation part generates the selection reference signal based on the first light receiving signals of the first light receiving arrays that respectively receive light reflected by the first tracks that reflect light emitted by the light source; the signal selection part selects, based on the selection reference signal, one of the two second light receiving signals of the two second light receiving arrays that respectively receive light reflected by the second tracks that reflect light emitted by the light source; and the position data generation part generates the position data based on one or more of the first light receiving signals and one of the second light receiving signals that is selected by the signal selection part.

Further, according to yet another aspect of the present invention, an encoder includes: a disc that is fixed on a rotating body; multiple first tracks that are provided on the disc and each have an incremental pattern along a measurement direction; one or more second tracks that are provided on the disc and each have an absolute pattern along the measurement direction; a light source that emits light to the first tracks and the second tracks; multiple first light receiving arrays that are arranged at mutually offset positions in a width direction perpendicular to the measurement direction and respectively receive light reflected or transmitted by the corresponding first tracks to respectively output first light receiving signals; two second light receiving arrays that respectively receive light reflected or transmitted by the corresponding second tracks to respectively output second light receiving signals having mutually different phases; and an encoder control device that generates a selection reference signal based on the first light receiving signals, selects one of the two second light receiving signals based on the selection reference signal, and generate position data of the rotating body based on one or more of the first light receiving signals and the selected one of the second light receiving signals.

According to an embodiment of the present invention, the reliability of the position data can be improved.

Obviously, numerous modifications and variations of the present invention are possible in light of the above teachings. It is therefore to be understood that within the scope of the appended claims, the invention may be practiced otherwise than as specifically described herein.

What is claimed is:

1. An encoder, comprising:
a disc coupled to a rotating body and having a plurality of first tracks and at least one second track;
a light source configured to emit light to the plurality of first tracks and second track of the disc;
a plurality of first light receiving arrays positioned at mutually offset positions in a width direction of the disc perpendicular to a measurement direction of the plurality of first tracks and second track such that the plurality of first light receiving arrays receives light reflected or transmitted by the plurality of first tracks and is configured to output a plurality of first light receiving signals, respectively;
two second light receiving arrays positioned to receive light reflected or transmitted by the second track such that the second light receiving arrays output two second light receiving signals having mutually different phases, respectively; and
a position data generation device configured to generate position data of the rotating body based on at least one of the first light receiving signals and one of the two second light receiving signals selected based on the plurality of first light receiving signals,
wherein the plurality of first tracks is formed on or in the disc such that each of the first tracks has an incremental pattern along the measurement direction, and the second track is formed on or in the disc such that the second track has an absolute pattern along the measurement direction.

2. An encoder according to claim 1, further comprising:
a signal generation device configured to generate a selection reference signal based on the plurality of first light receiving signals; and
a signal selection device configured to select one of the two second receiving signals based on the selection reference signal.

3. An encoder according to claim 1, wherein each of the first tracks has the incremental pattern such that each incremental pattern has a different pitch, and the position data generation device is configured to generate the position data of the rotating body based on the first light receiving signals and the one of the two second light receiving signals selected based on the plurality of first light receiving signals.

4. An encoder according to claim 2, wherein the two second light receiving arrays are positioned such that the light source is interposed between the two second light receiving arrays in the width direction of the disc, the plurality of first light receiving arrays includes at least one first light receiving array positioned on an inner side of the two second light receiving arrays with respect to the width direction of the disc, and the signal generation device is configured to generate the selection reference signal based on the plurality of first light receiving arrays.

5. An encoder according to claim 4, wherein the plurality of first light receiving arrays includes two first light receiving arrays positioned on the inner side of the two second light receiving arrays with respect to the width direction of the disc, and the signal generation device includes an average signal generation device and a first phase matching device such that the average signal generation device is configured to generate an average signal averaging first light receiving signals of the two first light receiving arrays and the first phase matching device is configured to match a phase of the selection reference signal and a phase of the average signal based on the average signal and the first light receiving signals.

6. An encoder according to claim 5, wherein the two second light receiving arrays are positioned symmetrical with respect to the light source in the width direction of the disc, and the two first light receiving arrays are positioned symmetrical with respect to the light source in the width direction of the disc.

7. An encoder according to claim 4, wherein the plurality of first light receiving arrays includes two first light receiving arrays positioned on the inner side of the two second light receiving arrays with respect to the width direction of the disc and two first light receiving arrays positioned on an outer side of the two second light receiving arrays with respect to the width direction of the disc, and the signal generation device includes a second phase matching device configured to match the phase of the selection reference signal and a phase of first light receiving signals of the two first light receiving arrays positioned on the inner side of the two second light receiving arrays.

8. An encoder according to claim 7, wherein the two first light receiving arrays positioned on the inner side of the two second light receiving arrays are positioned such that the light source is interposed between the two first light receiving arrays positioned on the inner side of the two second light receiving arrays in the measurement direction.

9. An encoder according to claim 1, wherein the plurality of first tracks and second track of the disc are configured to reflect the light emitted by the light source, the plurality of first light receiving arrays is configured to receive the light reflected by the plurality of first tracks, and the two second light receiving arrays are configured to receive the light reflected by the second track.

10. An encoder according to claim 2, wherein each of the first tracks has the incremental pattern such that each incremental pattern has a different pitch, and the position data generation device is configured to generate the position data of the rotating body based on the first light receiving signals and the one of the two second light receiving signals selected based on the plurality of first light receiving signals.

11. An encoder according to claim 3, wherein the two second light receiving arrays are positioned such that the light source is interposed between the two second light receiving arrays in the width direction of the disc, the plurality of first light receiving arrays includes at least one first light receiving array positioned on an inner side of the two second light receiving arrays with respect to the width direction of the disc, and the signal generation device is configured to generate the selection reference signal based on the plurality of first light receiving arrays.

12. An encoder according to claim 11, wherein the plurality of first light receiving arrays includes two first light receiving arrays positioned on the inner side of the two second light receiving arrays with respect to the width direction of the disc, and the signal generation device includes an average signal generation device and a first phase matching device such that the average signal generation device is configured to generate an average signal averaging first light receiving signals of the two first light receiving arrays and the first phase matching device is configured to match a phase of the selection reference signal and a phase of the average signal based on the average signal and the first light receiving signals.

13. An encoder according to claim 11, wherein the plurality of first light receiving arrays includes two first light receiving arrays positioned on the inner side of the two second light receiving arrays with respect to the width direction of the disc and two first light receiving arrays positioned on an outer side of the two second light receiving arrays with respect to the width direction of the disc, and the signal generation device includes a second phase matching device configured to match the phase of the selection reference signal and a phase of first light receiving signals of the two first light receiving arrays positioned on the inner side of the two second light receiving arrays.

14. An encoder according to claim 1, wherein an optical module comprising the light source, the plurality of first light receiving arrays and the two second light receiving arrays is positioned to face the disc.

15. A servo system, comprising:
the encoder of claim 1;
a motor comprising a stator and a rotor configured to rotate with respect to the fixed body; and
a control device configured to control the motor based on a detection result of the encoder,
wherein the disc is coupled to the rotor of the motor, and the encoder is configured to detect at least one of a position of the rotor and a speed of the rotor.

16. A method for generating position data of an encoder, comprising:
providing an encoder comprising a disc coupled to a rotating body and having a plurality of first tracks and at least one second track, a light source configured to emit light to the plurality of first tracks and second track of the disc, a plurality of first light receiving arrays positioned at mutually offset positions in a width direction of the disc perpendicular to a measurement direction of the plurality of first tracks and second track such that the plurality of first light receiving arrays receives light reflected or transmitted by the plurality of first tracks and is configured to output a plurality of first light receiving signals, respectively, and two second light receiving arrays positioned to receive light reflected or transmitted by the second track such that the second light receiving arrays output two second light receiving signals having mutually different phases, respectively; and
generating a position data of the rotating body based on at least one of the plurality of first light receiving signals and one of the two second light receiving signals selected based on the plurality of first light receiving signals,
wherein the plurality of first tracks is formed on or in the disc such that each of the first tracks has an incremental pattern along the measurement direction, and the second track is formed on or in the disc such that the second track has an absolute pattern along the measurement direction.

17. A method for generating position data of an encoder according to claim 16, further comprising:
generating a selection reference signal based on the plurality of first light receiving signals; and
selecting one of the two second receiving signals based on the selection reference signal.

18. A method for generating position data of an encoder according to claim 16, wherein each of the first tracks has the incremental pattern such that each incremental pattern has a different pitch, and the generating of the position data comprises generating the position data of the rotating body based on the first light receiving signals and the one of the two second light receiving signals selected based on the plurality of first light receiving signals.

19. A method for generating position data of an encoder according to claim 17, wherein the two second light receiving arrays are positioned such that the light source is interposed between the two second light receiving arrays in the width direction of the disc, the plurality of first light receiving arrays includes at least one first light receiving array positioned on an inner side of the two second light receiving arrays with respect to the width direction of the disc, and the generating of the selection reference signal comprises generating the selection reference signal based on the plurality of first light receiving arrays.

20. A method for generating position data of an encoder according to claim 19, wherein the plurality of first light receiving arrays includes two first light receiving arrays positioned on the inner side of the two second light receiving arrays with respect to the width direction of the disc, and the generating of the selection reference signal includes generating an average signal averaging first light receiving signals of the two first light receiving arrays and matching a phase of the selection reference signal and a phase of the average signal based on the average signal and the first light receiving signals.
